(19) United States
(12) Patent Application Publication
(10) Pub. No.: US 2025/0300193 A1
(43) Pub. Date: Sep. 25, 2025

(54) SIZE-SIEVING ENHANCED ZINC-IODINE FLOW BATTERY SYSTEM FOR MITIGATING WATER/HYDRATED ION CLUSTER MIGRATION

(71) Applicant: City University of Hong Kong, Hong Kong (HK)

(72) Inventors: Chunyi ZHI, Hong Kong (HK); Zhiquan WEI, Hong Kong (HK); Guojin LIANG, Hong Kong (HK)

(21) Appl. No.: 18/611,730

(22) Filed: Mar. 21, 2024

(51) Int. Cl. H01M 8/0234; H01M 8/18

(52) U.S. Cl. CPC H01M 8/0234; H01M 8/188; H01M 2220/10

(57) ABSTRACT

The present invention relates to a size-sieving enhanced zinc-iodine flow battery system for mitigating water/hydrated ion cluster migration. The zinc-iodine flow battery system includes an anolyte; a catholyte; an anode configured to be in contact with the anolyte; a cathode configured to be in contact with the catholyte; and a separator interposed between the anode and the cathode. The IMS-based membranes with selective transport of ions/molecules can address the longstanding issues of polyiodide cross-over and water migration. This improvement enables the development of long-duration hybrid Zn-based flow batteries.

### FIELD OF THE INVENTION

The present invention generally relates to the field of energy storage technologies, specifically focusing on advancements in ionic-molecular sieving (IMS) membranes for zinc-iodine flow batteries.

### BACKGROUND OF THE INVENTION

The latest form of long-duration energy storage (LDES) must require improved safety measures, extended duration, and reduced levelized cost. Aqueous flow batteries (AFB) distinguish themselves by enabling cost-effective large-scale energy storage while sustaining high power output.

Aqueous zinc-iodine flow batteries (Zn—I FBs) have emerged as promising candidates in energy storage technologies, driven by their potential for low cost, intrinsic safety, and a high theoretical specific capacity of 268 Ah L-1. To unlock the high energy density inherent in Zn—I FBs, key prerequisites include a high areal capacity for the zinc-based anode and a high operating state-of-charge (SOC) for the iodide cathode with elevated concentration. However, the pursuit of these conditions often leads to undesirable outcomes such as irreversible side reactions at the anode, exemplified by the formation of dendrites, and the problematic cross-over of polyiodine active species. Concurrently, the deposition process of the Zn metal anode is accompanied by a substantial loss of metal cations, exacerbating the challenge through significant water migration, often in the form of hydrated ion states, aggravating the issue of severe water imbalance. Most Zn—I FBs systems have not focused on the issue of water migration due to assessments being carried out under gentle operating conditions featuring low energy density, low SOC, and short lifespans, which directly dissatisfies Zn—I FBs entry into the grid storage market. The micro-scale processes of water/hydrated ions transport and the determining factors for its inhibition have not been explored in current Zn—I FBs.

Addressing these challenges primarily revolves around the modification of membranes, with a central focus on achieving reversibility in the Zn anode and controlling the cross-over of active species. Since the H₂O molecules generally cross the membrane in the form of hydrated ion clusters (I·(H₂O)n), the transport properties across the membrane could be regulated by the pore size, charged status, thickness, and other relevant parameters of the coating layer. Ionic-molecular sieve (IMS) with tailorable nano-channel was widely investigated to regulate the transport manners of different ions/molecules based on the size sieving effect. However, IMS membranes face certain dilemmas, particularly in the trade-off between ionic selectivity and conductivity. While IMS membranes have proven effective, there is currently a lack of comprehensive reporting on the systematic incorporation of their advantages into the design of Zn—I FBs systems.

### SUMMARY OF THE INVENTION

By delving into the intricate balance between ionic selectivity and conductivity inherent in IMS membranes, the present invention aims to develop innovative solutions that effectively address existing dilemmas. The ultimate goal is to contribute to the advancement of Zn—I FBs technology, providing valuable insights for the design and implementation of systems that demonstrate improved efficiency and reliability through the judicious incorporation of IMS layer-based membranes.

Accordingly, the present invention provides a size-sieving enhanced zinc-iodine flow battery system for mitigating water/hydrated ion cluster migration, including an anolyte; a catholyte; an anode configured to be in contact with the anolyte; a cathode configured to be in contact with the catholyte; and a separator interposed between the anode and the cathode. The separator comprises an ionic-molecular sieve membrane, offering precise size-sieving effects to prevent migration of water/hydrated ion clusters. The size-sieving enhanced zinc-iodine flow battery system demonstrates stable cycling at an areal capacity of 66.4 mAh cm⁻² and a volumetric capacity of 53.2 Ah L⁻¹_{posolyte} over at least 500 cycles at 50% state-of-charge.

In an embodiment, each of the cathode and anode further contains a carbon felt. The carbon felt has a geometric area of 1.0-5.0 cm² and a thickness of 1-5 mm.

Preferably, the carbon felt has a geometric area of 4 cm² and a thickness of 2.0 mm.

In an embodiment, the catholyte includes 6 M potassium iodide and 3 M zinc bromide.

In an embodiment, the anolyte includes 3 M zinc bromide and 3 M potassium chloride.

In an embodiment, the anolyte or the catholyte is disposed in a tank.

In an embodiment, the electrolytes (catholyte and anolyte) on the cathode and anode side are flowed by a peristaltic pump.

In an embodiment, ionic-molecular sieve membrane has a pore size of 0.55 nm to 0.65 nm.

In an embodiment, the ionic-molecular sieve membrane has a thickness of 20-40 μm.

When the ionic-molecular sieve membrane includes a supporting substrate, the complete ionic-molecular sieve membrane has a thickness of approximately 210 μm.

In an embodiment, the cathode uses graphite felt as the current collector.

In an embodiment, the anode uses graphite felt as the current collector.

In an embodiment, the size-sieving enhanced zinc-iodine flow battery system further includes a stainless-steel endplate, a PVC chamber, a PTFE gasket, a PTFE pad, a PTFE tube and a carbon plate.

In an embodiment, the size-sieving enhanced zinc-iodine flow battery system delivers a low self-discharge rate in retaining a coulombic efficiency of at least after static flowing for 3 days at 50% SOC.

Preferably, the size-sieving enhanced zinc-iodine flow battery system delivers a low self-discharge rate in retaining a coulombic efficiency of 98.5% after static flowing for 3 days at 50% SOC.

Compared to existing technologies, the notable advantages of the present inventions include:
(1) Demonstrated stable cycling of IMS-based membranes at a high areal/volumetric capacity of 66.4 mAh cm⁻²/53.2 Ah L⁻¹ posolyte over 2000 hours (500 cycles) at a 50% high state-of-charge (SOC).
(2) Effective mitigation of the pronounced water migration issue during operating processes through the utilization of IMS-based layers.
(3) The IMS membrane-enabled zinc-iodine flow batteries exhibit the potential to achieve competitive Levelized Cost of Storage (LCOS) for long-duration energy storage, surpassing the performance of zinc-bromine and zinc-iron-based flow batteries.

### BRIEF DESCRIPTION OF THE DRAWINGS

Embodiments of the invention are described in more details hereinafter with reference to the drawings, in which:

FIG. 1A shows a schematic illustration of Zn—I FBs battery for grid-scale energy storage. FIG. 1B depicts the zinc-dendrite/side-reaction on the negolyte side and cross-over of polyiodide (Ix-)/water migration on the posolyte side in Zn—I FBs with pristine membranes; and dendrite-free on the negolyte side and alleviating cross-over/water-migration on the posolyte side in Zn—I FBs with IMS-based membranes. FIG. 1C depicts properties and performances of membranes with different subnanometer pores towards hydrated ionic size;

FIG. 2A depicts crystal structure models of ZIF-8, Zn-MOF-CJ3, and MOF-5. FIG. 2B depicts XRD pattern of ZIF-8, Zn-MOF-CJ3, and MOF-5. FIG. 2C depicts XRD pattern of ZIF-8, Zn-MOF-CJ3, and MOF-5;

FIG. 3A shows schematic illustration and digital images of the membranes prepared with the slurry. FIG. 3B depicts schematic illustration of V-I testing device, and the cation transference numbers of K⁺, Na⁺, Zn²⁺. FIG. 3C depicts the cation transference numbers of K⁺, Na⁺, Zn²⁺ under ZIF-8 membrane, IMS membrane and MOF-5 membrane;

FIG. 4 depicts cation (K⁺, Na⁺ and Zn²⁺) mobilities calculated using I/V profiles by N117, MOF-5, Zn-MOF-CJ3, and ZIF-8 membranes;

FIG. 5A depicts ionic permeation measurements, where two-compartment H-cell testing configuration of 2 M KIₓ permeation using N117 membrane, MOF-5 membrane, IMS membrane and ZIF-8 membrane. FIG. 5B depicts I₃⁻ permeability and water migration of N117, MOF-5, IMS and ZIF-8 membranes;

FIG. 6A depicts two-compartment H-cell testing configuration of 2 M KIₓ permeation using N117 membrane. FIG. 6B depicts the cation transference numbers of K⁺, Na⁺, Zn²⁺;

FIG. 7A depicts SEM images of the Zn-MOF-CJ3. FIG. 7B depicts the corresponding EDS-mapping of IMS membranes;

FIG. 8A depicts surface morphology of IMS membranes. FIG. 8B depicts cross-section of IMS membranes. FIG. 8C depicts the corresponding EDS-mapping of IMS membranes;

FIG. 9 depicts UV-visible spectra of 10 mM KI₃ after soaking with 50 mg of Zn-MOF-CJ3 and CNT;

FIG. 10A depicts SEM images of the Zn-MOF-CJ3 after dipping in 0.1 M I₃⁻. FIG. 10B depicts the corresponding EDS-mapping of IMS membranes;

FIG. 11 depicts C Is, O 1s, Zn 2p and I 3d XPS depth profiles of Zn-MOF-CJ3@I₃⁻;

FIG. 12 depicts the zeta potential of N117, CNT, and IMS membranes saturated by KI_{1.5} in 1.0 mM KCl solution;

FIG. 13 depicts N is and Zn 2p XPS depth profiles of pristine Zn-MOF-CJ3 and activated Zn-MOF-CJ3;

FIG. 14 depicts Zn 2p XPS depth profiles of activated Zn-MOF-CJ3 and Zn-MOF-CJ3@I₃⁻, and I 3d XPS depth profiles of CNT@I₃⁻ and Zn-MOF-CJ3@I₃⁻.

FIG. 15 shows the evolution of bonding energy of I₃⁻ interacting with the Zn-MOF-CJ3 of metal/oxygen active sites and the electrostatic potential (ESP)-mapping of Zn-MOF-CJ3;

FIG. 16 depicts the interaction model between Zn-MOF-CJ3 and I₃⁻ under metal active sites and oxygen active sites;

FIG. 17A depicts snapshots of Nafion and IMS membranes (IMS@Nafion) at different times in an electric field (E) of 4.5 V/nm. FIGS. 17B-17C depict radial distribution function, corresponding coordination number and statistical distribution of hydrated K⁺ clusters at 300 ps using Nafion and IMS membrane;

FIG. 18 depicts SAXS profiles of N117, CNT and IMS membranes (d is the Bragg spacing);

FIG. 19 depicts two-dimensional scattering pattern of (h) N117 and (i) IMS membranes;

FIG. 20A depicts water uptake and swelling ratio of N117 and IMS membranes.

FIG. 20B depicts photographs of the swelling behavior of N117 and IMS membranes;

FIG. 21 depicts contact angle of water on N117 and IMS membranes;

FIG. 22 depicts photographs of the cell components of 2×2 cm² cell for flow cell tests;

FIG. 23 depicts schematic illustrations of hydrated K⁺ (K⁺·(H₂O)ₙ) clusters transport mechanisms across N117 and IMS membranes based on the surface zone, represented as nanochannels for simplicity. IMS membranes can freely transport the small hydrated K⁺ (K⁺·(H₂O)ₙₛ) clusters while significantly hinder the migration of large hydrated K⁺ (K⁺·(H₂O)ₙ₁) clusters;

FIG. 24A depicts CE, VE and EE of Zn—I FBs battery (5 ml of 6 M KI+3 M ZnBr₂∥IMS membrane∥5 ml of 3 M ZnBr₂+3 M KCl, 4 cm² membrane area) under 10, 20, 30 and 50 mA cm² at 50% SOC. The inset shows the prototype of Zn—I FBs flow-cell stack (5 ml of electrolytes, 4 cm² membrane area, for illustration). FIG. 24B depicts galvanostatic cycling of Zn—I FBs battery with IMS membranes and pristine N117 membranes;

FIG. 25 depicts galvanostatic cycling, voltage profiles and CE of Zn—I FBs with IMS membranes (5 ml of 6 M KI+3 M ZnBr₂∥5 ml of 3 M ZnBr₂+3 M KCl, 4 cm² membrane area, 50% SOC) under 10 and 20 mA cm²;

FIGS. 26A-26B depict galvanostatic cycling and voltage profiles of Zn—I FBs with N117 membranes (5 ml of 6 M KI+3 M ZnBr₂∥5 ml of 3 M ZnBr₂+3 M KCl, 4 cm² membrane area, 50% SOC) under 17 10, 20, 30 and 50 mA cm². FIG. 26C depicts CE of Zn—I FBs with N117 membranes;

FIG. 27 depicts CE of Zn—I FBs with IMS membranes (5 ml of 6 M KI+3 M ZnBr₂∥5 ml of 3 M ZnBr₂+3 M KCl, 4 cm² membrane area, 20% SOC) under 30 mA cm². (The inset: voltage profiles of Zn—I FBs with IMS membrane);

FIG. 28 depicts long cycling of high-energy Zn—I FBs flow-cell system (5 mL of 6 M KI+3 M ZnBr₂ IMS membrane∥mL of 3 M ZnBr₂+3 M KCl, 4 cm² membrane area) at 30 mA cm⁻² with the designated discharge duration (energy to power ratio, E/P) of 2.23 h. The insets show the representative voltage profiles over cycling, CE and volumetric/areal capacity during 500 cycles (2050 h);

FIG. 29 depicts photographs of the water flushing experiment on IMS membranes and digital images of residual in the water tank after 500 hours of water flushing under different flow rates;

FIG. 30 depicts self-discharge performance of Zn—I FBs at 50% SOC applying different membranes;

FIG. 31 depicts XRD pattern of N117, CNT and IMS membranes on the anode side in the discharging state after cycles, and XRD pattern of CF anode using N117, CNT and IMS membranes in the discharging state after cycles;

FIG. 32 depicts schematic illustration of Zn symmetric cells for testing Nyquist plots, and Nyquist plots of Zn symmetric cells with glass fiber, glass fiber@CNT and glass fiber@IMS membranes in different temperatures;

FIGS. 33A-33B depict the Arrhenius plot and calculated desolvation energy based on the charge-transfer resistances with glass fiber, glass fiber@CNT and glass fiber@IMS membranes;

FIG. 34 depicts CE, volumetric/areal capacity and working lifetime, compared with reported previously works based on Zn-polyhalide FBs;

FIG. 35A depicts bulk energy storage LCOS analysis of Zn—Br FBs, Zn—Fe FBs and Zn—I FBs as a function of discharge duration E/P (180 cycles per annum (p.a.), interest rate 8%, electricity price (Electricity-P) USD-20 MWh⁻¹). The grey zone indicates the price range for commercial VRFBs; the dashed plot indicates the price for AQFBs; the black arrows indicate E/P greater than 18 h;

FIG. 35B depicts breakdown of the LCOS with a discharge duration of 18 h for Zn—Br FBs, Zn—Fe FBs and Zn—I FBs including electricity cost (E-Cost), operation and maintenance (O&M) cost, and investment cost. The grey zone indicates the price range for commercial VRFBs; the dashed plot indicates the price for AQFBs;

FIG. 35C depicts normalized Installed cost breakdown including energy cost (C_{E}, including chemical costs and tank cost), power cost (C_{P}), balance-of-plant cost (C_{bop}) and additional cost (C_{add}) for 270 kWh/15 kW (upper) and 3600 kWh/15 kW (lower) Zn—I FBs systems. The left (light color) and right (dark color) charts represent the present and projected future costs of the Zn—I FBs system, respectively; and

FIG. 36A depicts long discharge duration cycling performance of Zn—I FBs flow battery. 41 mL 6 M KI+3 M ZnBr₂∥IMS membrane∥41 mL 3 M ZnBr₂+3 M KCl Zn—I FBs flow cell at 120 mA with E/P=18 h (50% SOC). FIG. 36B depicts representative voltage profile of Zn—I FBs flow battery. FIG. 36C depicts CE and capacity retention of Zn—I FBs flow battery over 1,000 hours cycling.

### DETAILED DESCRIPTION

In the following description, zinc-iodine flow batteries and ionic-molecular sieving (IMS)-based membranes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

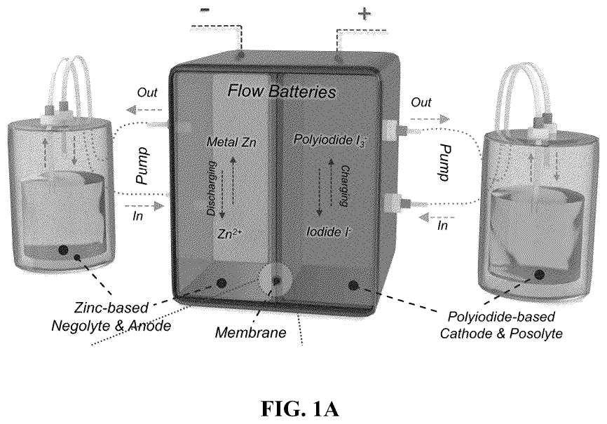

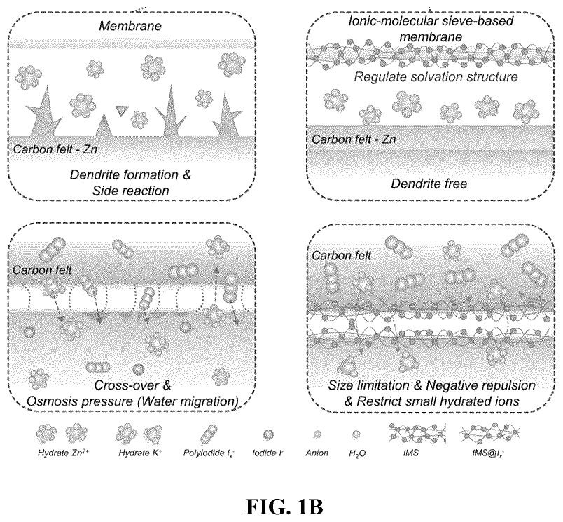

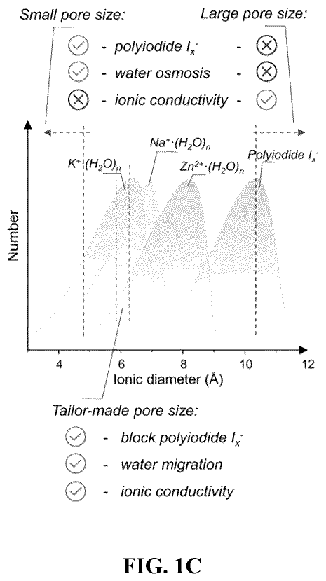

Aqueous zinc-iodine flow batteries (Zn—I FBs) have emerged as promising redox chemistry systems for grid storage due to their inherent safety, high energy density, and cost-effectiveness. Zn—I FBs demonstrate significant promise owing to their low cost, inherent safety, and impressive theoretical volumetric capacity of 268 Ah L⁻¹. However, the hybrid anodic process involving Zn metal deposition/dissolution induces severe water migration due to ionic imbalance at high areal/volumetric capacities, resulting in exacerbating intrinsic challenges within practical Zn—I FBs. Turning to FIG. 1B, achieving the high energy density of practical Zn—I FBs requires high areal capacity for the zinc-based anode and a high operating state-of-charge (SOC) for the iodide cathode. Given the hybrid nature of the Zn—I FBs configuration, these practical performance requirements often lead to irreversible side reactions at the anode (e.g., dendrites) and detrimental cross-over of polyiodine active species. In contrast to fully-flowing FBs (e.g., vanadium-based systems), water out-of-balance stands as the core bottleneck issue in hybrid FBs mainly originating from the imbalance of the ions concentration due to the inevitable deposition/dissolution process at the Zn anode side. Ionic-molecular sieve (IMS) with tailorable nano-channel has been widely investigated to regulate the transport manners of different ions/molecules based on the size sieving effect. Consequently, the developed IMS-coated composite membranes possess high potential to improve the performance of Zn—I FBs.

Nevertheless, IMS-based membranes face a trade-off dilemma between ionic selectivity and conductivity when striving to be compatible with various ions and H₂O molecules present in negolyte/posolyte electrolytes. Specifically, with excessively smaller pore sizes in the IMS, these membranes could effectively impede the issues of polyiodide cross-over and water migration (FIG. 1C, top-left), while those membranes unavoidably lead to low ionic conductivity due to the restricted ions flux within FBs systems, resulting in low operating power density. When the pore size of the membrane is expanded to enhance ion transport (FIG. 1C, top-right), it compromises selectivity for iodide active species and hydrated ions, resulting in low coulombic efficiency and water out-of-balance in negolyte/posolyte electrolytes. Such water imbalance due to hydrated ions migration from negolyte to posolyte would trigger a volumetric loss of negolyte and the cascade Zn dendrite growth, culminating in battery deactivation.

Taken together, the regulation relationship between the nanostructure of IMS and the electrochemical performance of the Zn—I FBs was not elaborated, and the design principle of IMS-based membranes for high-performance Zn—I FBs systems has not yet been systematically developed. The construction of IMS-based membranes remains a desirable but challenging task, involving the simultaneous accommodation of a specific level of ionic conductivity and high selectivity for the active iodine species and H₂O molecules (FIG. 1C-bottom).

In light of this, the present invention introduces tailored and novel ionic-molecular sieving (IMS)-based membranes (Zn-MOF-CJ3) featuring subnanometer channels specifically designed to confine hydrated ions. Additionally, the invention employs these tailored IMS-coated membranes to effectively alleviate water/hydrated ions migration and block polyiodide shuttling. This is achieved through size-sieving and ionic repulsion based on the strong chemisorption of the IMS layer.

Compared to traditional ionic-molecular sieves, the enhanced Zn-MOF-CJ3 possesses a greater number of active sites for adsorbing polyiodides. This feature proves advantageous in creating a localized high-concentration iodine layer on the membrane surface, effectively preventing the crossover of polyiodides. The IMS-based membranes typically permit the passage of Iodine ions (I₃) while blocking the molecular form of Iodine (I). This is crucial for the formation of the Iodide layer.

The IMS-based membranes effectively filter hydrated ion clusters during transfer, mitigating the imbalance of electrolytes caused by a significant migration of water/hydrated ions. This, in turn, enhances the reversibility of Zn—I FBs. Benefiting from the coordination effect of the DMF solvent, the modified Zn-MOF-CJ3 can actively transport the coordination solvent even at high temperatures (e.g., 180° C.), thereby providing additional sites for the absorption of polyiodides. Meanwhile, the activated Zn-MOF-CJ3 can still maintain the well-matched pore size structure.

In one embodiment, the ionic-molecular sieving membrane has a pore size of 0.55-0.65 nm.

The flow-prototype Zn—I FBs system containing 6 M KI+3 M ZnBr₂/3 M ZnBr₂₊₃ M KCl electrolytes accommodates a stable cycling over 3 months (500 cycles) with a high areal/volumetric capacity of 66.4 mAh cm⁻²/53.2 Ah L⁻¹_{posolyte} and high CE of 99% under 50% SOC.

In one embodiment, the as-developed Zn—I FBs systems delivered a low self-discharge rate in retaining a high CE of at least 95% after static flowing 3 days.

Preferably, the Zn—I FBs systems delivered a low self-discharge rate in retaining the CE of 98.5% after static flowing 3 days.

The size-sieving effect of the enhanced Zn-MOF-CJ3, characterized by tailored subnanometer pores in the IMS layer, restricts the transport of large-hydrated ion clusters. This restriction alleviates H₂O migration and the volume imbalance of the electrolyte, thereby enhancing the reversibility of electrochemical reactions within the negolyte and posolyte.

Moreover, techno-economic analysis indicates that Zn—I FBs enabled by IMS membranes hold the potential to attain a competitive Levelized Cost of Storage (LCOS) for long-duration energy storage.

Additionally, the present invention also provides a systematic membrane modification method for improving Zn—I flow battery system.

The modified Zn-MOF-CJ3, featuring increased active sites and tailored pore sizes, can effectively absorb the Iₓ⁻ species. This absorption facilitates the creation of a localized high-concentration iodine surface on IMS membranes through ionic repulsion, relying on strong chemisorption.

In summary, subnanochannel Ionic-Molecular Sieve (IMS)-based membranes, which selectively transport ions/molecules, can effectively address longstanding issues such as polyiodide crossover and water migration. This tailored approach contributes to the prolonged performance of hybrid Zn-based flow batteries. The subnanometer pores in the IMS layer exhibit a size-sieving effect, limiting the transport of large hydrated ion clusters. This mitigates electrolyte volume imbalances caused by extensive water migration, thereby enhancing the reversibility of electrochemical reactions in both negolyte and posolyte compartments. Additionally, the subnanochannel chemistries of the IMS layer enable strong interactions with polyiodides, leading to the formation of a localized high-concentration iodine layer. This layer serves to impede the activity of iodine species through electrostatic repulsion.

### EXAMPLE

### Example 1-1

### Source of Materials

All chemicals were used as received. Zinc bromide (ZnBr₂, ≥98%), zinc acetate (Zn(Ac)₂, ≥99%), potassium chloride (KCl, ≥99%), potassium iodide (KI, ≥99.5%), sodium chloride (NaCl, ≥99.5%), potassium hydroxide (KOH, ≥98%), sulfuric acid (H₂SO₄, 95%-98%), hydrogen peroxide (H₂O₂, 30 wt % in H₂O), iodine (I₂, ≥99%), zinc nitrate hexahydrate (Zn(NO₃)₂·6H₂O, ≥99%), 2-methylimidazole (≥98%), triethylamine (H₃BTC, AR, ≥99.5%), trimesic acid (AR, ≥98%), Terephthalic acid (AR, ≥99.5%), N, N-Dimethylformamide (DMF, AR, ≥98%), ethanol (AR, ≥99.5%), methanol (AR, ≥99.5%) and 1-Methyl-2-pyrrolidinone (NMP, AR, ≥99%) were received from Sigma-Aldrich. Graphite felt (3.0 mm, carbon ≥99%, bulk density 0.12-0.14 g cm⁻²) was received from Yi Deshang Carbon Technology. Nafion membrane (N117, Dupont) was received from Shanghai Hesen Electric. Carbon nanotubes were received from XFNANO Technology. Ti foil (99.9%, 100 m) was obtained from Kangwei Metal. Zn foil (200 μm, 99.99%) was purchased from Chenshuo Metal. PVDF (HSV900) binder was received from Taiyuan Lizhiyuan Batteries.

### Example 1-2

### Characterizations

The distribution of pore size was tested by BET (Micromeritics ASAP 2460). The crystal structure was studied by X-ray diffraction (XRD, X'Pert Pro MPD, Philips, Holland) using Cu Kα as the radiation source under 40 kV and 40 mA. Morphologies were probed by scanning electron microscopy (SEM, FEI Quanta 450 FEG SEM). X-ray photoelectron spectroscopy (XPS) spectra were recorded on a photoelectron spectrometer (ESCALAB 250, Thermo Scientific, America), where the binding energy (BE) of the elements was calibrated by the BE of C is (284.60 eV).

### Density Functional Theory (DFT) Calculation

All the computations were conducted based on the density functional theory (DFT) using the Cambridge Sequential Total Energy Package (CASTEP) code of the Materials Studio 2019 software. The generalized gradient approximation (GGA) with the Perdew-Burke-Ernzerhof (PBE) functional were used to describe the electronic exchange and correlation effects. The kinetic-energy cutoff was set as 500 eV. The geometry optimization within the conjugate gradient method was performed with forces on each atom less than 0.05 eV/Å. Additionally, the converge thresholds for energy and force were set to 10⁻¹ eV and 0.02 eV/Å, respectively. The adsorption of iodine species on the Zn-MOF-CJ3 is modeled by placing the I₃⁻ on different active sites. Brillouin zone was sampled by a y a k-point mesh of 1×1×1. The binding energy of the configuration (E_{bind}) was calculated by the following equation:

$${E}_{b i n d} = {E}_{A B} - ( {E}_{A} + {E}_{B} )$$

where E_{A}, E_{B}, and E_{AB} respectively represent the energies of A (I₃⁻) and B (Zn-MOF-CJ3) and the complex energy, a negative value of E_{bind} indicates that the process is an exothermic reaction and a high negative value corresponds to a stronger interaction, which indicates more heat release and a more stable product.

### Example 2

### Synthesis of Ionic Molecular Sieve (Zn-MOF-CJ3)

Zn-MOF-CJ3 crystals were modified and synthesized by a hydrothermal method. In a typical procedure, 0.872 g of Zn(Ac)₂ was dissolved in 25 mL of mixed solution (DMF:ethanol:DI H₂O) and sonicated for 20 mins. 1 g of H₃BTC was dispersed into 25 mL of the same mixed solution (DMF:ethanol:DI H₂O) and sonicated for 20 mins. Afterward, these two solutions were mixed and stirred for another 20 mins. 0.5 mL of triethylamine was slowly added to the above solution and then stirred for 24 h. The mixture was sealed into a PTFE-lined autoclave and then transferred into a preheated oven at 80° C. for 16 h under static conditions. After cooling to room temperature, the product was centrifuged and washed with DMF, methanol and DI H₂O three times each and finally dried at 60° C. under vacuum for 16 h, The obtained white product was then used as the Zn-MOF-CJ3. The activated Zn-MOF-CJ3 was calcined at a low temperature of 150° C. for 3 h in nitrogen with a heating rate of 2° C. min⁻¹.

### Synthesis of ZIF-8 or MOF-5

A solid mixture of Zn(NO₃)₂·6H₂O (0.525 g) and 2-methylimidazole (0.015 g) was dissolved in DMF (9 mL) in a 12 mL Teflon-capped vial which was heated at a rate of 2° C. min⁻¹ to 130° C., held at this temperature for 24 h, and then cooled at a rate of 5° C. h⁻¹ to room temperature. Colorless polyhedral crystals were filtered from the reaction mixture, washed with methanol 3 times and dried in air.

Zn(NO₃)₂·6H₂O (1.19 g) and terephthalic acid (0.34 g) were dissolved in 40 ml of DMF during vigorous stirring at room temperature. Three drops of H₂O₂ aqueous solution (30 wt %) was added to the solution. Triethylamine (2.3 ml) was slowly added dropwise to the above solution under vigorous agitation for 1 h. The white product was collected by repeated filtering, thorough washing with DMF for three times. The sample was degassed firstly at room temperature for 6 h, then heated to 180° C. at a heating rate of 2° C. min⁻¹ and held at this temperature for 12 h under degassing in vacuum.

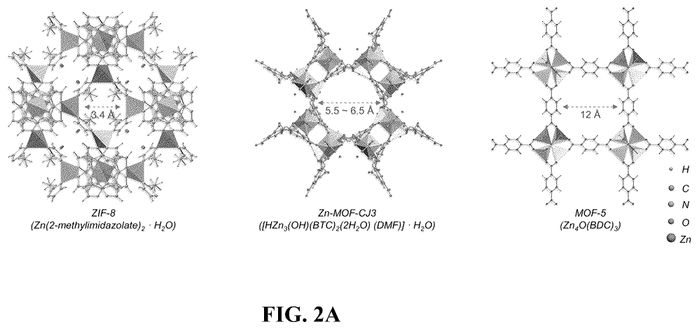

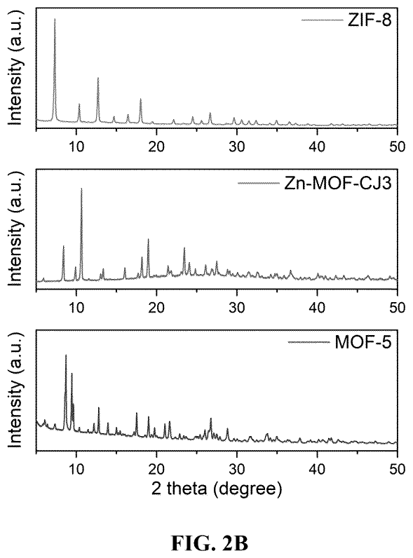

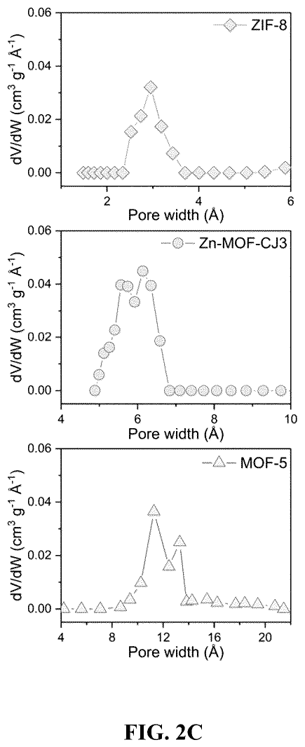

As shown in FIG. 2A, three-typed molecular sieves of ZIF-8, MOF-5, and Zn-MOF-CJ3 (IMS) were synthesized to accommodate different subnanochannel configurations with different pore sizes, respectively. FIG. 2B showed the powder X-ray diffraction (XRD) patterns of above molecular sieves. In addition, based on BET results, the pore size distributions of ionic molecular sieves showed that ZIF-8 had a pore size of ≈3 Å, Zn-MOF-CJ3 had a pore size of ≈z5.5-6.5 Å and MOF-5 had a pore size of ≈12 Å (FIG. 2C), which were in accord with the previous reports.

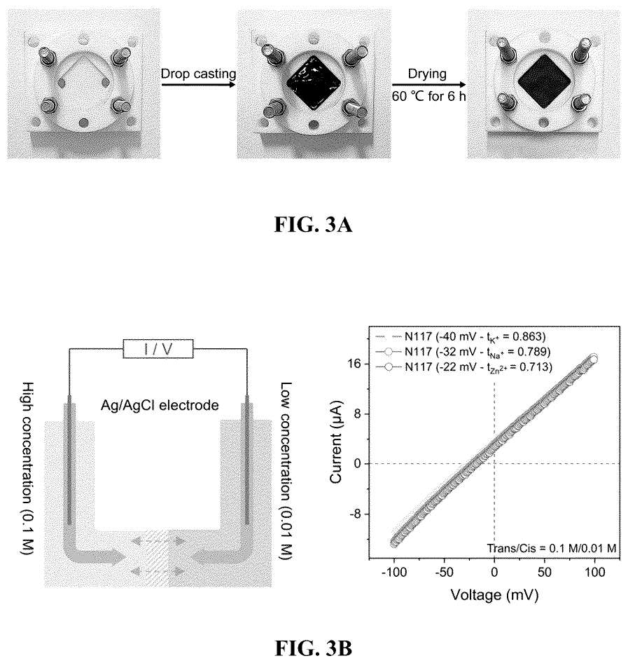

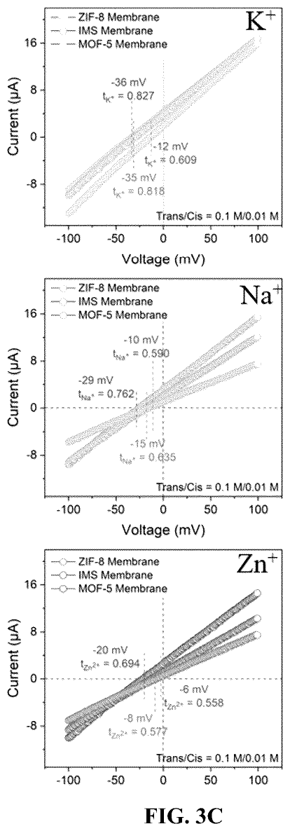

The selective ionic transport modes in these ionic-molecular sieves-based membranes (ZIF-8, IMS, and MOF-5 membranes) were investigated using concentration-driven dialysis diffusion tests, as shown in FIGS. 3A-3C. The ion transport numbers for the cation-exchange membranes were investigated using CHI electrochemical testing unit (760E). The V-I profile was tested by two Ag/AgCl reference electrodes when the membrane was sandwiched between two cells soaking with different KCl concentration gradients (0.1 M 0.01 M, FIG. 3A). Thus, reversal potential (Vᵣₑᵥ) can be calculated as the following equation:

$${V}_{r e v} = ( 2 {t}_{{K}^{+} , {Na}^{+} or {Zn}^{2 +}} - 1 ) \frac{R T}{F} ln Δ$$

R, T, F, t_{K+, Na+, or Zn2+} and Δ are the gas constant, temperature, Faraday constant, K⁺, Na⁺ and Zn²⁺ transference number, respectively.

It is noteworthy that carbon nanotubes (CNT) and polyvinylidene fluoride (PVDF) within the coating layer functioned as the supporting dispersive framework and the binder, ensuring the uniform dispersion of ionic molecular sieves to prevent their agglomeration.

### Example 3

### Preparation of IMS Membranes and Reference Membranes

Nafion membranes were pretreated before utilization. First, membranes were treated with 5% H₂O₂ under 80° C. for 1 h and then were transferred to 5% H₂SO₄ at 80° C. for 1 h. Finally, 1.0 M KOH aqueous solution was used to change the H-type (that is, proton conductive) Nafion membranes to K⁺ conductive type under 80° C. for 2 h. The membranes were rinsed in DI H₂O for 30 min to wash away the chemicals after each step. IMS membrane was prepared by drop casting the slurry of Zn-MOF-CJ3:CNT:PVDF=8:1:1 in NMP. The slurry was mixed uniformly by sonication and the loading of Zn-MOF-CJ3 on each side of N117 was controlled by the volume of slurry, which is equivalent to 1 mg cm⁻². The membrane was dried at 60° C. for 3 h and stored in DI H₂O to recover the ionic conductivity before testing.

In fabricating other membranes, Zn-MOF-CJ3 were replaced with ZIF-8 or MOF-5 to form the slurry, which prepare the membranes under the same conditions with preparation of IMS membranes.

As displayed in FIG. 4, the order of the cation transference numbers through these four membranes is hydrated-state K⁺>Na⁺>Zn²⁺. Specifically, MOF-5 membranes showed almost the same ionic selectivity as pristine N117 membranes, due to the largest subnanometer pore size of the MOF-5. In contrast, ZIF-8 membranes exhibited the lowest metal cation transference number, which can be attributed to the interception of the large hydrated K⁺ with the hydration shell diameter (approximately 6.62 Å) by the small subnanometer pore diameter size (<3 Å) of ZIF-8.

The prepared IMS membranes showed a slightly decreased transference number of hydrated K⁺ and highly suppressed transference capability for the hydrated Na⁺/Zn²⁺. Notably, the radius of hydrated ion changes with the quantity of water in the solvation shell layer, in which the hydration level/number of K⁺·(H₂O)ₙ (n=1-8) follows a normal distribution (the optimal coordination number: 6, the corresponding diameter: 6.62 Å). This result means the small hydrated K⁺·(H₂O)ₙₛ(ns=1-4) with less solvation water could effectively pass through the IMS layer to retain a high K⁺ ionic conductivity. Therefore, the IMS-based selective layer exhibited the sieving effect on hydrated K⁺, owing to tailor-made subnanometer pore frameworks of Zn-MOF-CJ3.

### Example 4

### Absorption Ability of Zn-MOF-CJ3 by UV-Visible Spectra

To study the permeability of active polyiodide species through the membranes with different pore sizes of the coated molecular sieves, two-compartment H-cells consisting of 2 M KI₃ in one cell and deionized water in counterpart cell was used to evaluate by the UV-visible absorption spectra.

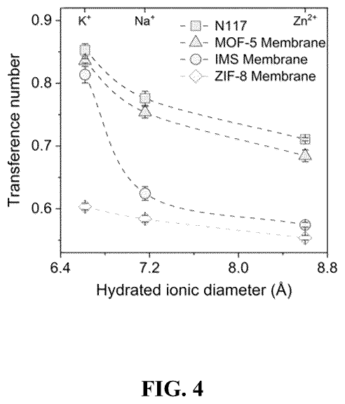

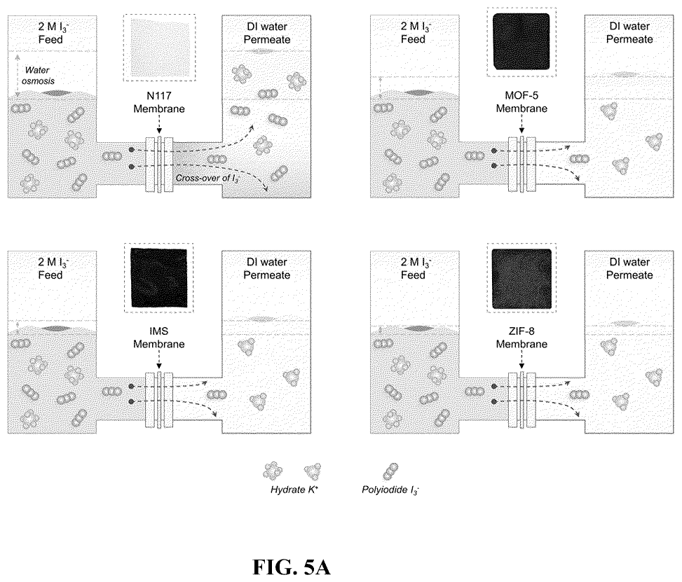

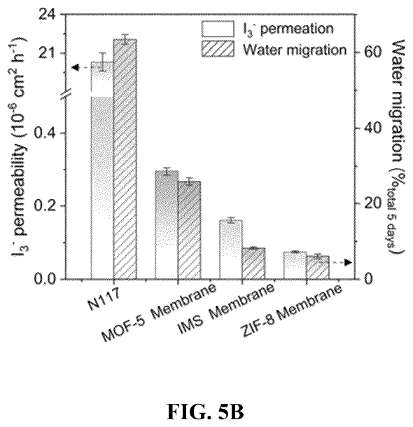

The permeability of KI₃ through different membranes was determined from the evolution of the UV-visible spectra of the permeate side in H-cell tests in FIG. 5A. The feed reservoir was filled with 2 M KI₃, while the permeate side was filled with deionized water. The two reservoirs had a circularly symmetrical transport channel separated by different membranes. It was assumed that the change of KI₃ concentration in the feed solution reservoir was negligible when their concentration in the permeation side was low and the flux of KI₃ through the membrane is a constant; that is, a pseudo-steady-state condition prevails in the two reservoirs during experiments.

$${V}_{B} \frac{d {c}_{B} ( t )}{d t} = \frac{A P}{L} [ {C}_{A} - {C}_{B} ( t ) ]$$

$$ln ( 1 - \frac{{C}_{B} ( t )}{{C}_{A}} ) = - \frac{A P}{L {V}_{B}} [ t - {t}_{0} ]$$

where c_{A} and c_{B}(t) are the concentrations (mol L⁻¹) of KI₃ in the feed and permeate side, respectively; A and L are the area (cm²) and thickness (cm) of the membrane, respectively; V is the volume of the permeate solution (ml); P is the membrane permeability (cm² min⁻¹); t is the time (min), and to is the time lag (min). The permeability P could be determined from the slop of the plot of −ln(1-c_{B}(t)/c_{A}) versus t.

UV-visible spectra were collected using a PerkinElmer Lambda 1050+UV-Vis/NIR spectro-photometers. A 10 mM KI₃ solution was prepared by dissolving 10 mM KI:I₂=1:1 into DI H₂O. Zn-MOF-CJ3 or CNT powders (50 mg) was added into 1 ml of prepared solutions. The clear solution was taken out after vigorous stirring overnight and centrifuging. Multiple concentrations of KI₃ (0.1-1 mM) were characterized by UV-visible spectra in advance to determine the standard Beer's law plot as reference.

The permeability of I₃⁻ in FIG. 5B-left followed the order of N117 (2.11×10⁻⁵ cm² h⁻¹)>MOF-5 membranes (3.04×10⁻⁷ cm² h⁻¹)>IMS membranes (1.68×10⁻⁷ cm² h⁻¹)>ZIF-8 membranes (7.66×10⁻⁸ cm² h⁻¹). It indicated the selective coating layer could effectively inhibit the crossover issue of the active iodine species across the membrane.

Moreover, concerning the unmodified Nafion membrane, it should be noted that although the migration of negatively charged polyiodide species is expected to be rejected by the Donnan exclusion effect, the cross-over can still diffuse through the micropores and swelling channels of the Nafion membrane.

The water migration for 5 days was further compared in FIG. 5B-right, which indicated that a decrement in pore size is associated with a proportional reduction in the volume of water migration.

### Example 5

### Elucidating the Role of IMS

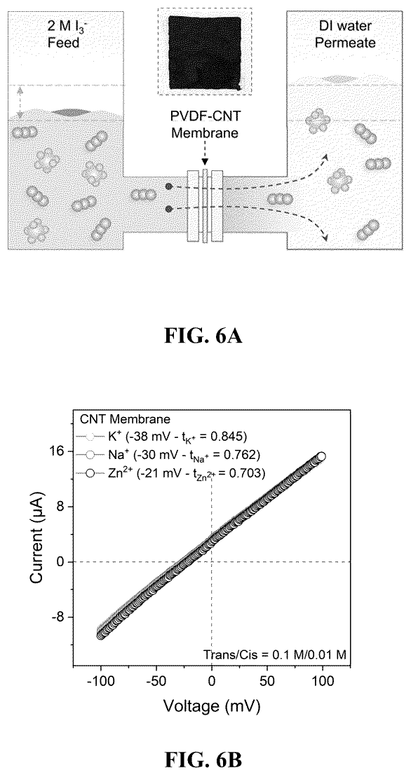

The ionic selectivity, polyiodide permeability and water migration of CNT-based membranes without IMS were comparatively investigated. Turning to FIGS. 6A-6B, there were few differences in these parameters of the CNT-based membrane compared with the pristine N117 membranes, further implying the highly selective sieving effect of the IMS. Based on the aforementioned analysis, IMS (Zn-MOF-CJ3)-based membranes with well-matched pore sizes demonstrate a balanced performance across key factors essential for high-performance Zn—I FBs. This includes maintaining superior ion conductivity, limiting the permeability of Ix-active redox species, and curbing water migration induced by the transport of large-sized hydrated ions. Consequently, Zn-MOF-CJ3 and its derived IMS membranes were chosen as the prototypical materials for subsequent investigations.

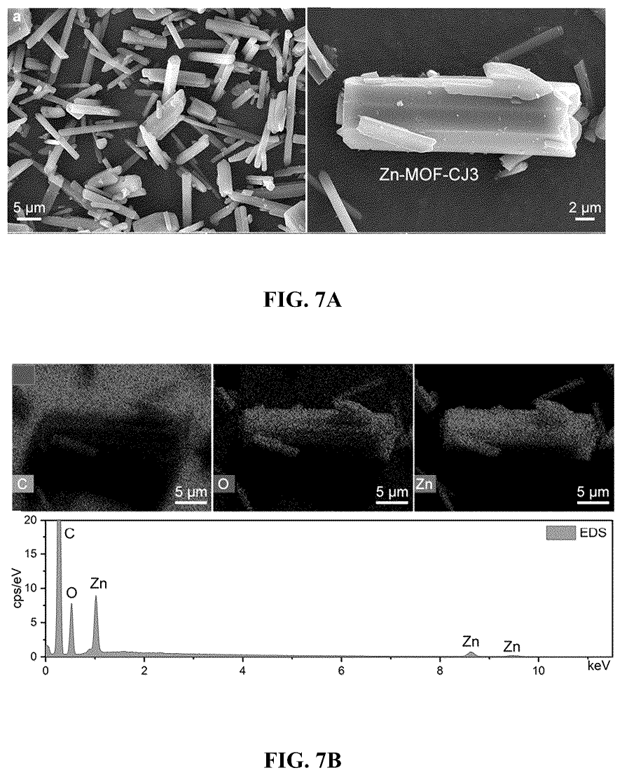

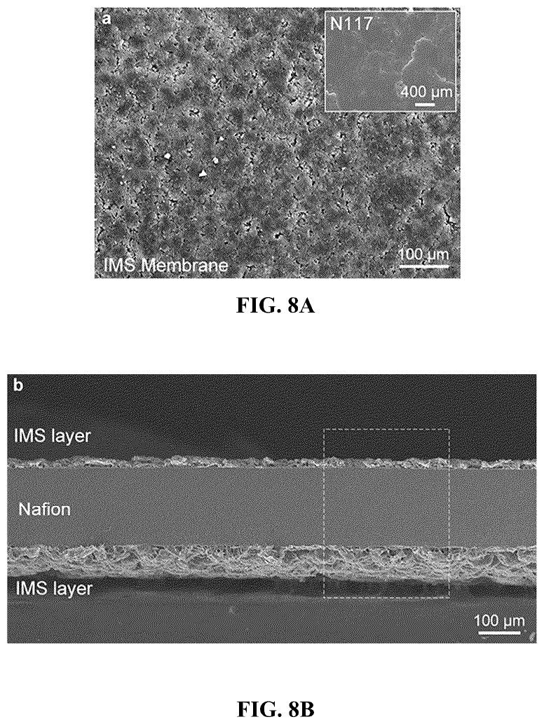

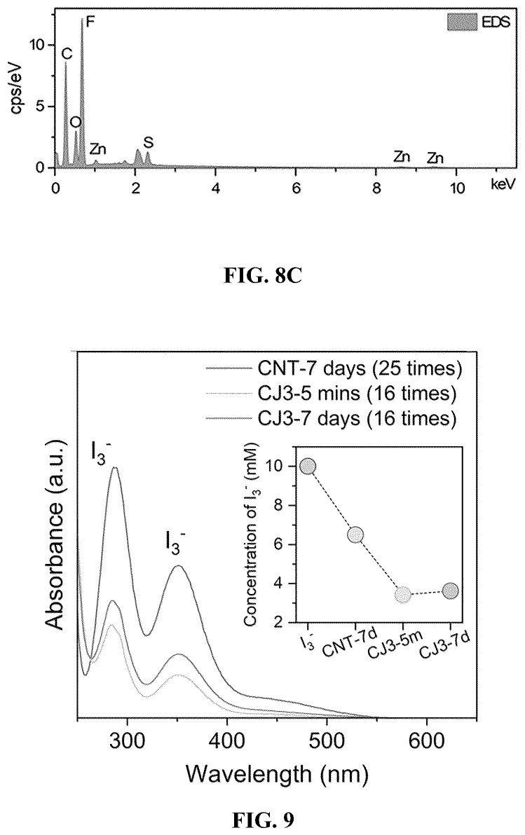

As clearly shown in FIGS. 7A-7B, the Zn-MOF-CJ3 was featured with the rod-shape of uniform elemental distribution. After drop casting-coating the synthesized Zn-MOF-CJ3 nanoparticles onto the two sides of the supporting N117 membrane, the smooth IMS (Zn-MOF-CJ3) layer showed a thickness of about 10±1 μm (FIGS. 8A-8C). UV-visible spectra were tested by as-prepared KI₃ solutions before and after soaking with Zn-MOF-CJ3 and CNT, respectively (FIG. 9). UV-visible absorbances associated with I₃⁻ (288 nm and 350 nm) more dramatically decreased after soaking in Zn-MOF-CJ3 than in CNT, and slightly increased after soaking for 5 days based on Zn-MOF-CJ3.

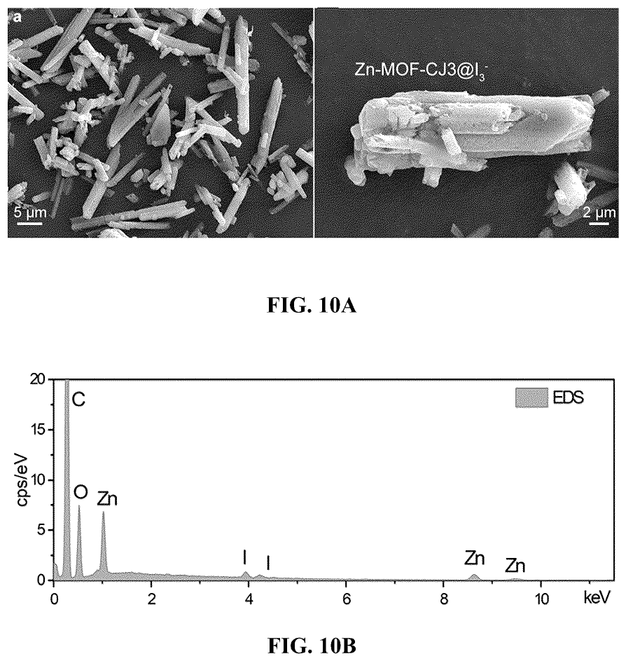

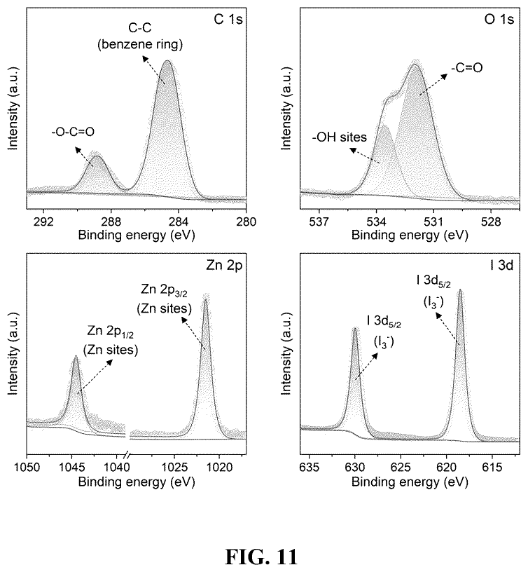

Moreover, elemental mapping patterns of Zn-MOF-CJ3@I₃⁻ further demonstrated the absorption of active species (FIGS. 10A-11). These observations can indirectly demonstrate that IMS membranes with nanochannel chemistry accommodated a strong polyiodide absorption ability/stability.

### Example 6

### Zeta Potential Measurement

Considering the strong polyiodide capability of the IMS, a localized high concentration iodide layer would be constructed within the IMS layer during battery operation. To examine the electrostatic repulsion of membranes, zeta potential measurements of the N117, CNT and IMS membranes were conducted. The zeta potential magnitude serves as a measure of the extent of electrostatic repulsion, wherein a negative zeta potential signifies the prevalence of a negative net charge on the membrane surface.

The zeta potentials of the membrane were conducted using streaming potential measurement performed with the SurPASS system (Anton Paar) by Malvern Nano ZS90. The zeta potential (ζ) could be calculated on the basis of the Helmholtz-Smoluchowski (H-S) equation:

$$ζ = \frac{dU}{dp} \frac{η}{{εε}_{0}} κ$$

where dU/dp is the slope of the streaming potential (U) versus the pressure (p), η is the electrolyte viscosity, e is the electrolyte permittivity, ε₀ is the vacuum permittivity and κ is the electrolyte conductivity. Before measurement of the zeta potential, both N117, CNT and IMS membranes were saturated in 0.5 M KI_{1.5} for 48 h, then rinsed with a large amount of DI H₂O to eliminate free KI_{1.5} electrolytes, followed by drying under a dynamic vacuum at 40° C. A 1.0 mM KCl aqueous solution was employed as the standard electrolyte for the streaming potential measurement of the membranes.

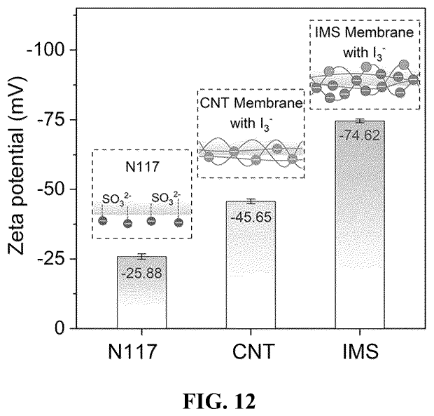

Turning to FIG. 12, all measurements showed negative zeta potentials resulting from the absorbed negatively charged polyiodide in Zn-MOF-CJ3 (KI_{1.5}-soaked, −74.62 mV) and intrinsic negatively charged functional groups in N117 (KI_{1.5}-soaked, −25.88 mV). Notably, the magnitude of zeta potentials of IMS membranes was substantially higher than that of CNT membranes (KI_{1.5}-soaked, −45.65 mV), which suggested that IMS membranes had a stronger electrostatic repulsion strength against anions compared to counterparts.

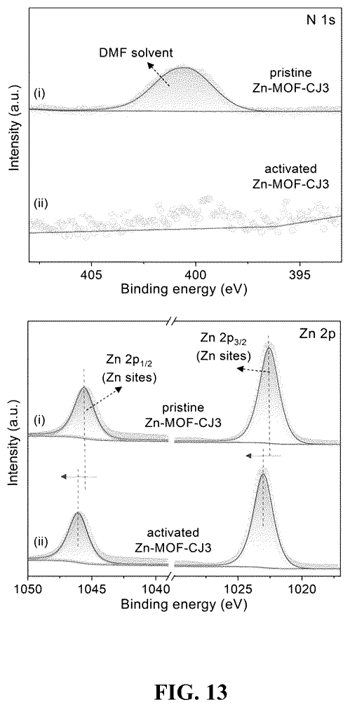

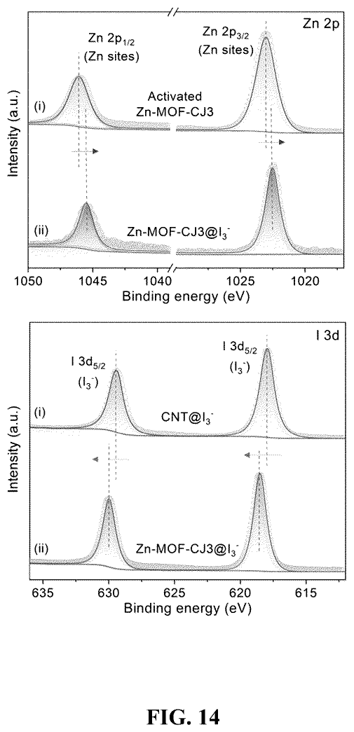

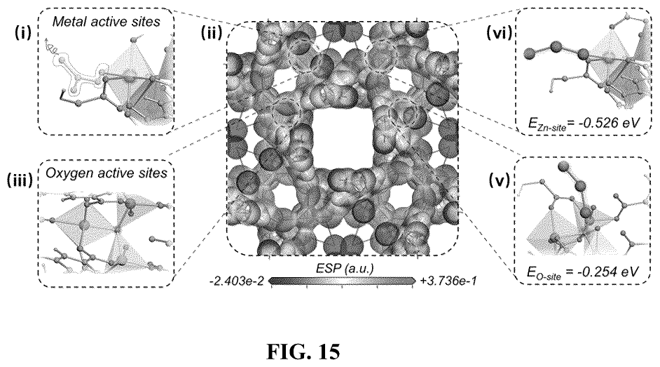

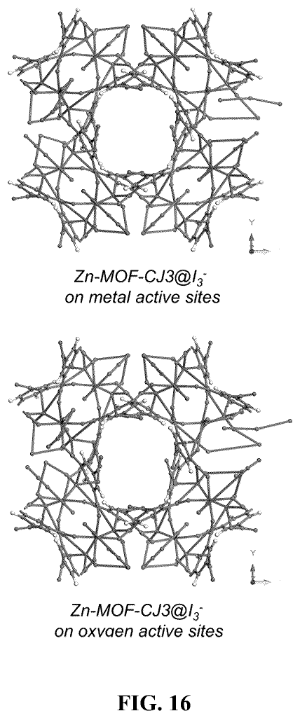

To further comprehend the adsorption-active sites between polyiodide species and Zn-MOF-CJ3, the atomic binding state was explored. In general, metal active sites would be activated by the removal of coordinating solvent molecules, which can be confirmed by the positive-shifts of binding energy of the Zn 2p spectrum in FIG. 13. The negative-shifts of binding energy in the high-resolution Zn spectra were observed for Zn-MOF-CJ3@I₃⁻ compared with activated Zn-MOF-CJ3 (FIG. 14A), implying the occurrence of electronic interaction between Zn-MOF-CJ3 and adsorbed polyiodide species (FIGS. 15(i)). Furthermore, the more positive-shifts of binding energy in the high-resolution I 3d spectra were shown for Zn-MOF-CJ3@I₃⁻ compared with CNT@I₃⁻ (FIG. 14A), which indicated the strong chemical absorption rather than physical absorption between Zn-MOF-CJ3 and active redox. Referring to FIG. 15(ii), the molecular electrostatic potential (ESP) was further employed to analyze the active sites of absorbing I₃⁻. Generally, regions with more positive ESP tend to interact with polyiodides. The simulated potentials for both the Zn atom (FIG. 15(i)) and O atom (FIG. 15(iii)) with surrounding sites exhibited the strong electron-deficient center, which were conductive to boost the chemical interaction of polyiodide I₃⁻ species with Zn-MOF-CJ3. The results can be illustrated through the computation of adsorption energy at these active sites, providing a measure of the interaction strength at various locations. As shown in FIG. 15(vi) and (v)) and FIG. 16, metal and oxygen active sites both reflected superior polyiodide absorption ability.

This thorough examination emphasizes the I₃⁻ capability exhibited by Zn-MOF-CJ3 when employed as an ionic-molecular sieving layer in Zn—I flow battery (FBs) systems. It effectively establishes a localized high-concentration iodide layer, thereby mitigating the crossover of polyiodides in Zn—I FBs.

### Example 7

### Restrained Hydrated Ion Clusters Migration Though IMS Membranes

Owing to ions existing in hydration states, the transport of hydrated ions would be accompanied by substantial water migration, thereby controlling the coordination number of hydrated ions across membranes can significantly inhibit electrolytes out-of-balance.

To support this hypothesis, molecular dynamics (MD) simulations were employed to calculate representatively smallest hydrated metal ions (K⁺·(H₂O)ₙ=1-8) transport through Nafion and IMS membranes.

For Molecular dynamics (MD) simulations, two electrolyte simulation systems were prepared by combining two bulk solution boxes separated by an ion exchange membrane. One of the ion exchange membranes was composed of Nafion, while the other was modified with a Zn-MOF-CJ3 of size 2×2×1 in addition to Nafion. The left bulk solution box contained a 6 M KI and 3 M ZnBr₂ solution, while the right box contained pure water. The total number of water molecules in both bulk solution boxes was 4728. The Nafion membrane consisted of five Nafion polymer anions, each with 10 repeated units, and contained water molecules with a water content of 20. Additionally, hydrated hydrogen ions were added to the system to maintain electrical neutrality during the simulation.

The simulations were performed using the open-source molecular dynamics simulation software package LAMMPS. After energy minimization, the system was allowed to equilibrate at a temperature of 300K for more than 4 ns. Then, a 4.5 V/nm electric field was applied to the K⁺ to drive them rapidly through the ion exchange membrane. Trajectory information was collected to calculate the radial distribution function (RDF) and coordination number. To maintain a constant coordination number of water molecules around K ions, an additional bond interaction was applied to the K⁺ and the oxygen atoms of water molecules, with an equilibrium distance of 0.28 nm. Note that a higher electric field was used in the simulation than in experiments to facilitate data collection on a shorter time scale.

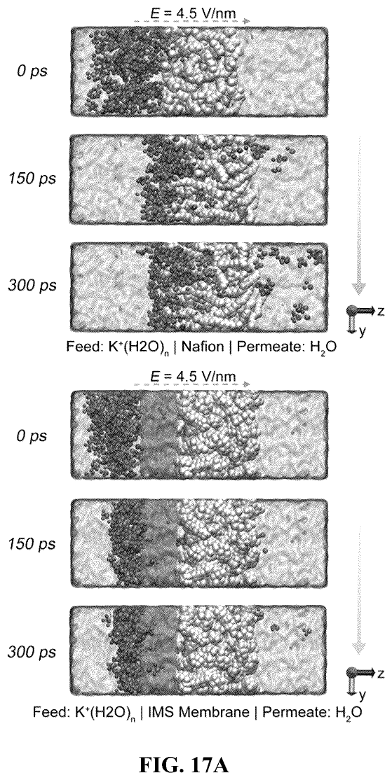

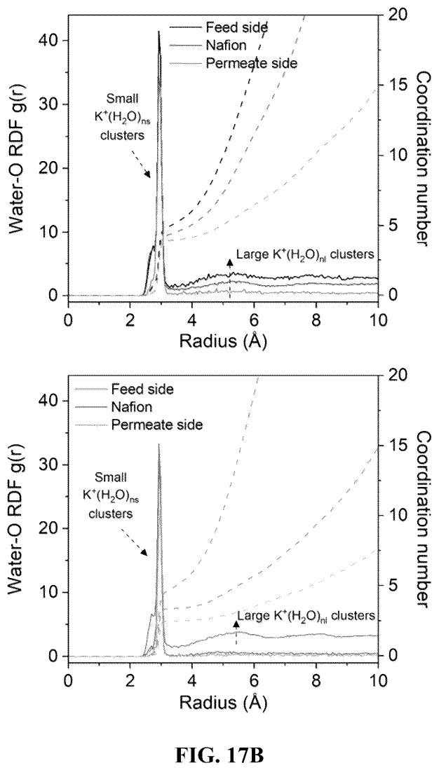

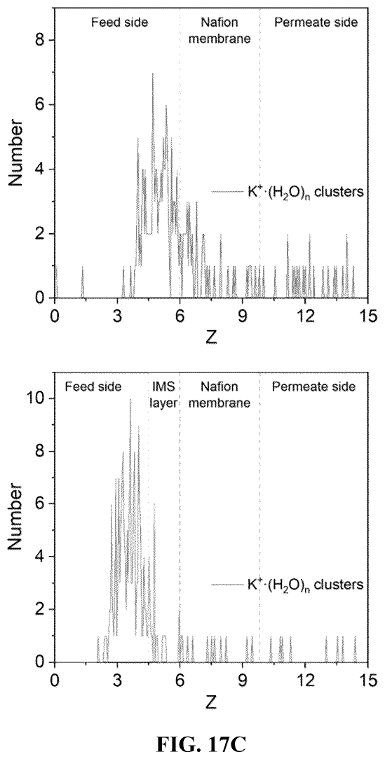

The MD simulations clearly showed no significant interception for K⁺·(H₂O), clusters in Nafion membranes, as shown in snapshots of FIG. 17A. In contrast, IMS membranes with the tailoring subnanometer pores could block large hydrated K⁺ clusters (K⁺·(H₂O)ₙ₁, n1=5-8).

FIGS. 17B-17C showed the radial distribution function and statistical distribution of the oxygen atoms on water molecules surrounding K⁺ ions, respectively. Based on Nafion membranes, it can be found that K⁺·(H₂O)ₙ clusters can be easily diffused into permeate side, resulting in electrolyte migration during flow batteries operation. In comparison, K⁺·(H₂O)ₙ₁ clusters with larger solvation shell in IMS membranes were confined to the feed side, while small hydrated K⁺ clusters (K⁺·(H₂O)ₙₛ, ns=5-8) were distributed in the whole systems due to the free-transport across the IMS membranes, indicating the sized selective permeability of IMS layer.

### Example 8

### Small-Angle X-Ray Scattering (SAXS)

SAXS data were collected using a Xeuss 2.0 instrument (Xenocs) with an incident X-ray wavelength of =0.154 nm. SAXS/wide-angle X-ray scattering patterns were recorded in a q range of 0.1 nm⁻¹<q<10 nm⁻¹, where q=(4π sin θ) is the length of the scattering vector and 2θ is the scattering angle. On the basis of Bragg's law d=2π/q, where d is the hydrated K⁺ cluster size in the nanodomains. Both samples of N117, CNT and IMS membranes were soaked in 0.1 M KCl solution and then were taken out from fully hydrated K⁺ states for SAXS tests. The coating layer on CNT and IMS membranes was removed with Kimwipes immediately before the experiment to probe the information on membrane substrates.

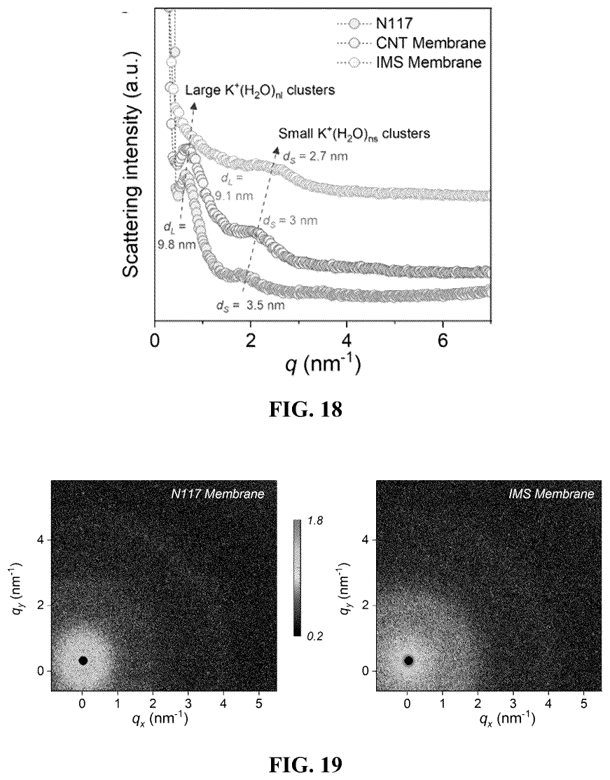

The SAXS technique was used to probe the hydrated-ion cluster size in N117, CNT and IMS membranes. Referring to FIG. 18, the SAXS pattern of N117 and CNT membranes both showed two scattering ionomer peaks at q≈0.66 nm⁻¹ and q≈1.8 nm⁻¹, translating to a larger K⁺·(H₂O)ₓ cluster size for N117 (9.8 nm) and CNT (3.5 nm) according to the Bragg equation, respectively. In contrast, there was no signal of large K⁺·(H₂O)ₙ₁ clusters observed on IMS membranes, only the existence of small K⁺·(H₂O)ₙₛ clusters, which was due to the ionic-selective limitation of the IMS layer.

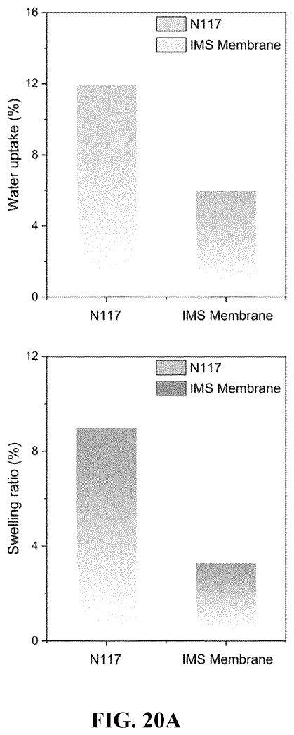

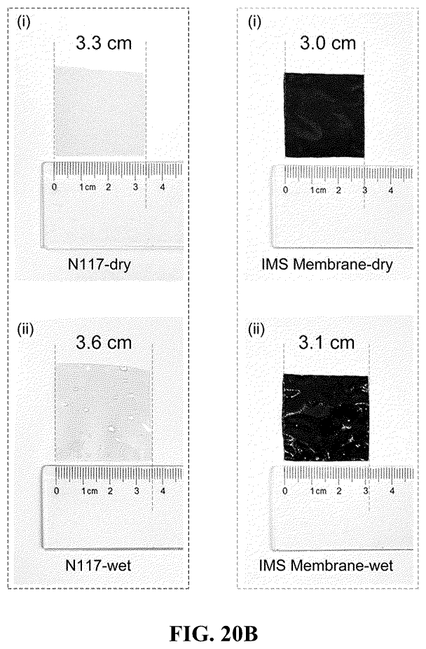

Meanwhile, the two-dimensional SAXS patterns (FIG. 19 and FIGS. 20A-20B) were isotropic for both membranes, revealing an isotropic dispersion and orientation of heterogeneities within both polymers. Hence, IMS membranes demonstrated superior control over the migration of hydrated ion clusters compared to their counterparts, aligning with the findings of MD simulations.

### Example 9

### Water Uptake and Swelling Ratio

The membrane's resistance to water uptake is another crucial parameter for preserving the structural integrity of the membrane and ensuring stable ion transport.

Samples of fully hydrated N117 and IMS membranes were soaked in DI H₂O under the designated temperature for over one day in advance. Samples of fully dried N117 and IMS membranes were prepared by vacuum drying under 80° C. for >48 h. The water uptake (p) was determined as the weight ratio of the absorbed water to the dry membrane:

$$φ = \frac{{m}_{h} - {m}_{d}}{{m}_{d}}$$

where mₕ and m_{d} are the weights of hydrated and dry membranes, respectively. The mₕ values of both membranes were obtained quickly after wiping off the surface water using Kimwipes. The swelling ratio was defined as the ratio of the length increase of the swollen membranes to that of the dry membranes:

$$swelling ratio = \frac{{l}_{h} - {l}_{d}}{{l}_{d}}$$

where lₕ and l_{d} are the lengths of the hydrated and dry membranes, respectively.

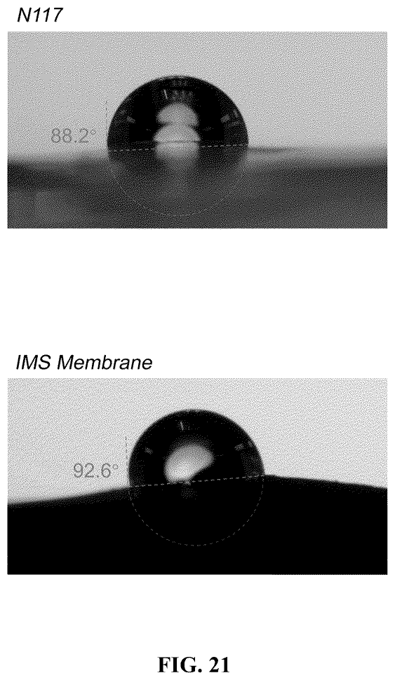

Turning to FIG. 21, the swelling behavior of IMS and N117 membranes was explored. Specifically, the IMS membrane exhibited a much lower water uptake and swelling ratio compared to N117. This can be attributed to the IMS layer's ability to suppress the uptake of water clusters and its hydrophobic features.

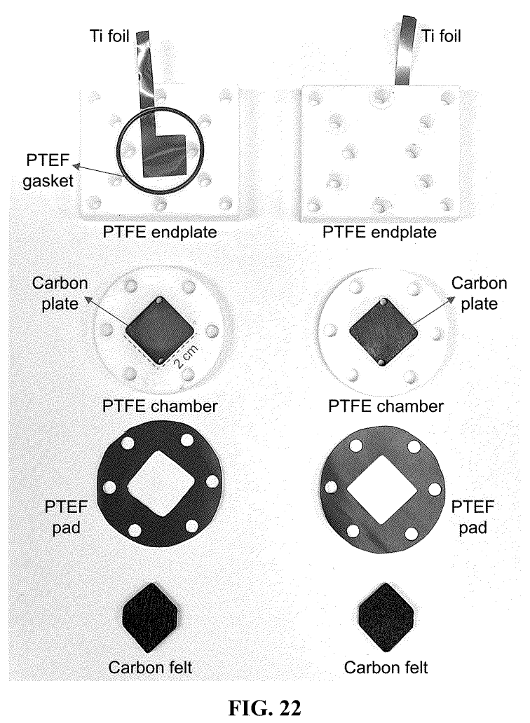

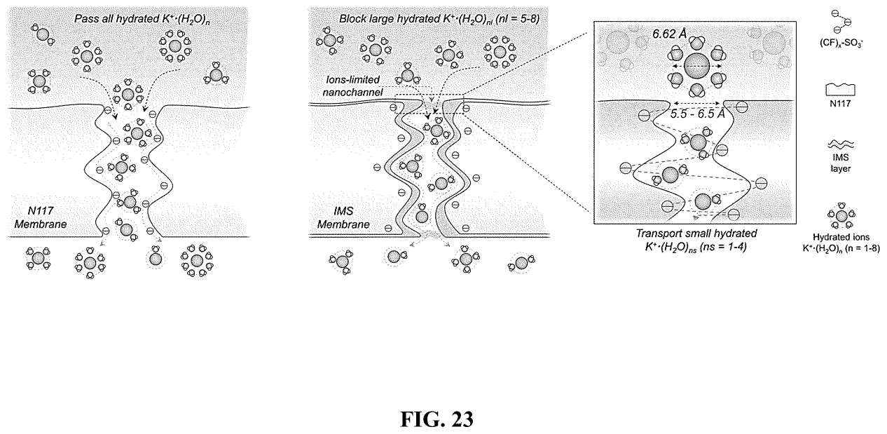

The hydrophobic feature of IMS-coated membranes was further supported by the larger contact angle of IMS membranes compared to that of pristine N117 (FIG. 22). The above results illustrated the water clusters would aggregate in the ionic conduction channels and swell the Nafion structure during the transport process of the hydrated ions (FIG. 23). On the contrary, the inclusion of the IMS layer could endow the ionic-sized selectivity for the IMS-based membrane, which reduced the transportation for hydrated ions with highly coordinated water number, preventing the expansion and swelling of the water/ion-exchange channels. Therefore, based on the microscopic analysis of the transport process of hydrated ions, the IMS membrane with tailor-made pores could effectively limit the passage of larger hydrated K⁺ through a size-sieving effect, alleviating water migration. This favorable characteristic contributes to achieving long-duration Zn-based flow batteries under high areal capacity/SOC conditions.

### Example 10

Electrochemical Performance of Zn—I FBs with IMS Membranes

Catholyte composed of 6 M KI+3 M ZnBr₂ was dissolved in DI H₂O. Anolyte was prepared with 3 M ZnBr₂+3 M KCl in DI H₂O. The Zn—I FBs cell assembly configuration: briefly, polytetrafluoroethylene (PTFE) frames were served as the flow channel to fix the position of the pretreated three-dimensional electrodes with a geometric area of 4.0 cm² (2×2 cm²) and thickness of 2.0 mm (FIG. 16). Graphite felt was utilized as both the anode and cathode electrode. To make a flow-mode cell, a peristaltic pump (Chuang Rui Precision Pump) was employed to power circulation of the electrolyte flow through the electrodes.

EIS measurements were carried out on a CHI 760E. The sinusoidal voltage oscillations of 10 mV amplitude at the OCV of the cells were collected before tests. The oscillation frequencies ranged from 1,000 kHz to 100 mHz with three repetitions for every test.

The galvanostatic characterizations of the Zn—I FBs cells were conducted on a battery testing system (LAND, CT2001A) at room temperatures (23-25° C., unless otherwise specified). The current densities were set in the range 10 to 50 mA cm⁻², and the cell voltages were set in the range 0.2 V to 1.9 V. The charging process was limited by the constant capacity (107 mAh or 268 mAh) and discharging process was limited by cut-off voltage of 0.1V. The theoretical capacity was calculated with the catholyte (the iodide part), which was the capacity-limiting side for the full cell.

Polarization of the Zn—I FBs was conducted to determine the area-specific resistance of the Zn—I FBs. The cell was first charged to 50% SOC at 10 mA cm⁻², and a linear sweep voltammetry (LSV) step was followed at the scanning rate of 100 mV s⁻¹ from the OCV to 0 V.

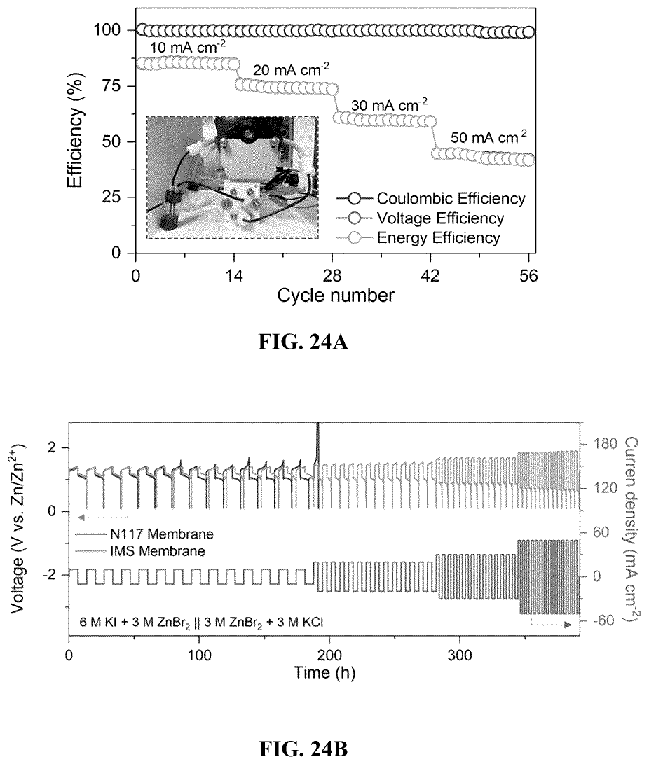

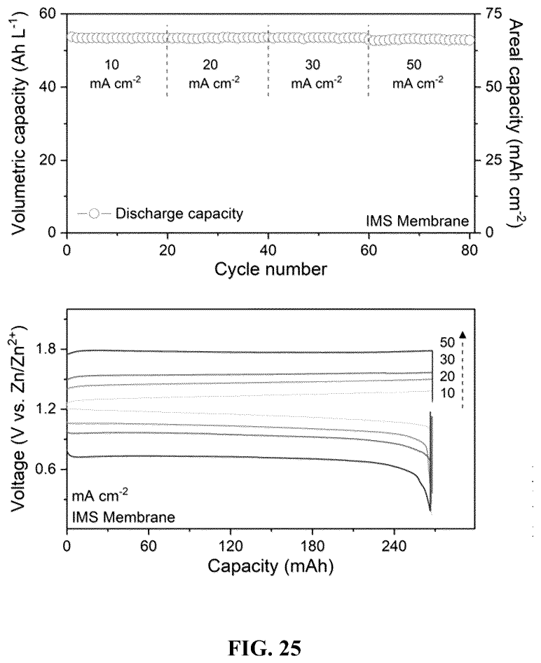

As shown in the inset of FIG. 24A and FIG. 22, the electrochemical performance of flow batteries with IMS membranes was evaluated by constructing a prototype Zn—I FBs in a flow-mode. During 80 cycles of operation (FIGS. 24A-24B and FIG. 25), no obvious decay in coulombic efficiency (CE), voltage efficiency (VE) and energy efficiency (EE) were observed for the flow-mode Zn—I FBs using IMS membranes. It should be noted that the electrochemical performance of Zn—I FBs were evaluated on the high concentration polyiodide-based posolyte to embody the advantageous high energy density of the Zn-based FBs, which delivered a large volumetric capacity of 53.2 Ah L⁻¹_{posolyte} (5 mL 6 M KI+3 M ZnBr₂|5 mL 3 M ZnBr₂+3 M KCl at 50% SOC) and the corresponding areal capacity is 66.4 mAh cm⁻².

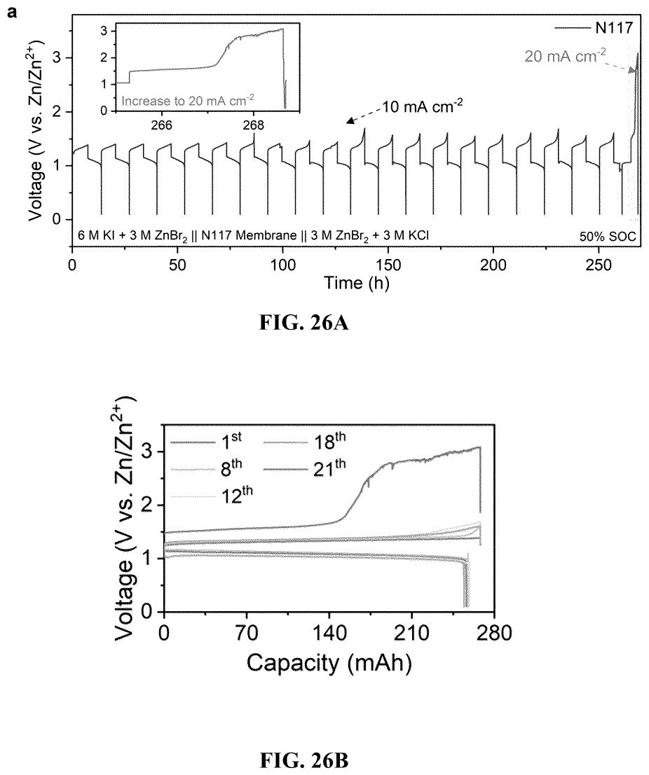

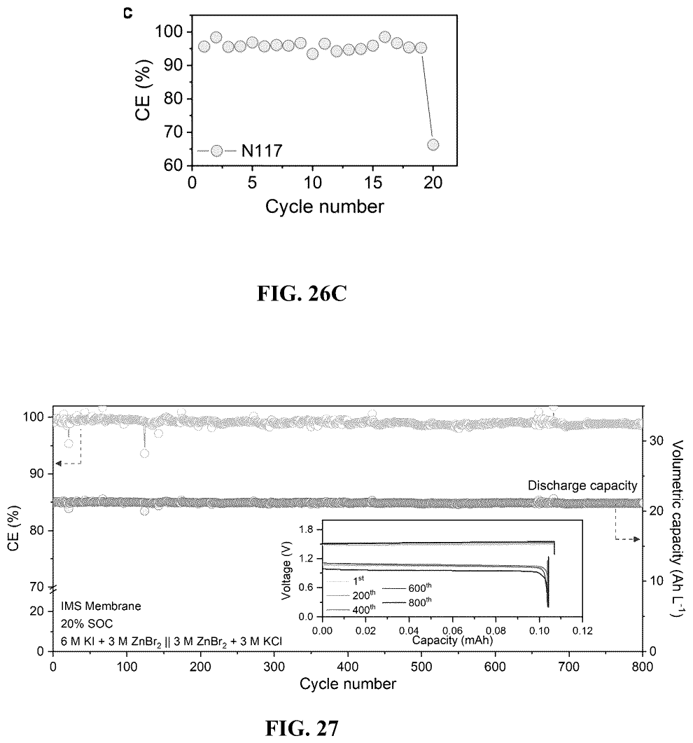

In contrast, as displayed in FIGS. 26A-26C, the N117-based FBs system exhibited inferior rate capability and larger polarizations on account of severe cross-over and water migration. Thus, the reversible cycling within a broad power density range (10-50 mA cm⁻²) under flow-states showcases the promising potential of IMS membranes for meeting the demands of stable large-scale energy storage applications across various power requirements.

### Example 11

Cycling Performance of the Zn—I FB with IMS Membranes

The cycling performance of the Zn—I FB with IMS membranes was evaluated at 20%-SOC of the iodine posolyte. Zn—IS FBs delivered a stable charge-discharge operation over 1000 cycles at 30 mA cm⁻² with stable CE (average >99.0%), realizing the volumetric capacity of 21.4 Ah L⁻¹_{posolyte} (FIG. 27).

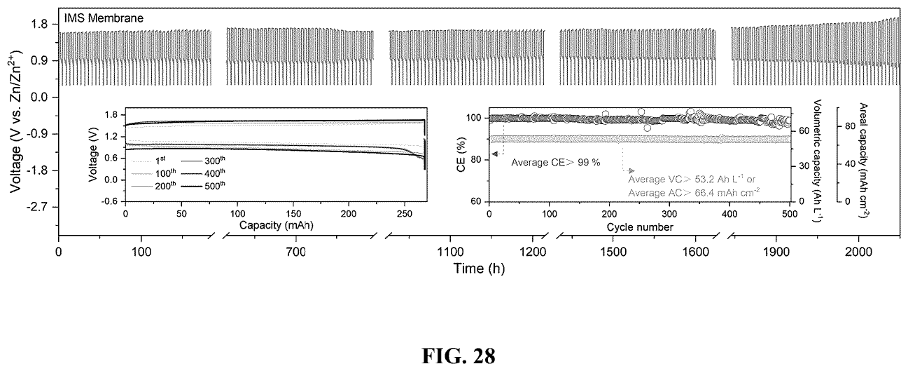

Furthermore, the energy of the flow cell was increased by increasing 50%-SOC (5 mL 6 M KI+3 M ZnBr₂ 5 mL 3 M ZnBr₂+3 M KCl), the scale-up IMS membranes-based Zn—I FBs flow system with a designated charge capacity of 268 mAh operated stably for 500 cycles (>2050 h) with no obvious CE decay at an average of 99.0%, as demonstrated in FIG. 28.

The flow system of the present invention demonstrated long cycling calendar life with a high volumetric/areal capacity (53.2 Ah L⁻¹_{posolyte}, 66.4 mAh cm⁻²). Compared to CNT and N117 membranes-based Zn—I FBs under the same working condition, both FBs systems showed inferior CE (CNT membranes: about 98.21%; N117: about 97.14%) with severe capacity loss, lower discharging volumetric capacity (CNT membranes: about 51.76 Ah L⁻¹_{posolyte}; N117: about 52.38 Ah L⁻¹_{posolyte}) and short cycle lifespan (CNT membranes: about 500 h; N117: about 170 h) due to the severe cross-over, and water migration. Therefore, the high Coulombic efficiency (CE) and cycle stability observed in IMS membrane-based systems illustrate that the IMS layer possesses superior restriction capabilities on polyiodides, contributing to high CE, and exhibits an excellent suppression effect on water migration for stable cycling.

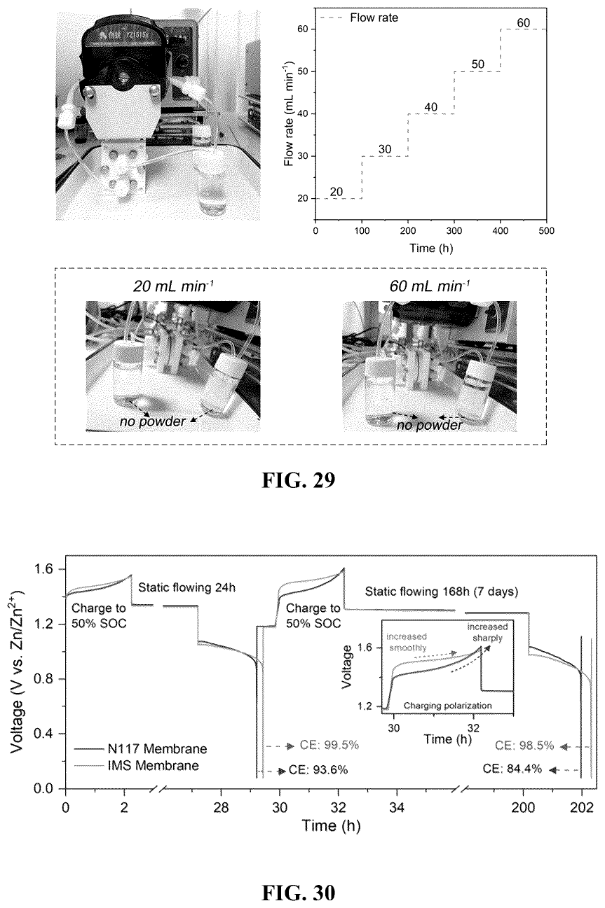

It is noteworthy that the IMS coating layer was uniform and dense before and after 100 times of mechanical bending with no powder residuals peeling off. In addition, no powder residuals were observed in the reservoirs after a 500 h water-flushing test in flow-cell configuration with flow rates ranging from 20 to 60 ml min⁻¹ (FIG. 29), which indicated that the superior mechanical performance of IMS membranes could support cycling stability in Zn—I FBs. On the other side, based on the long cycling test, the volume of negolyte decreased continuously while the volume of posolyte increased substantially over 96 h of long cycling. In contrast, the volumes of both posolyte and negolyte showed a slight change over 800 h in using IMS membranes for Zn—I FBs testing. The effective mitigation of hydrated ions migration with IMS membranes has proven instrumental in preventing flow battery failures caused by imbalanced electrolytes, specifically addressing issues such as negolyte precipitation and posolyte flooding.

Furthermore, the self-discharge performance of Zn—I FBs at 50% SOC applying different membranes were investigated (FIG. 30). The self-discharge of Zn—I flow batteries (FBs) using IMS membranes was suppressed compared to that using the N117 membrane. The Coulombic efficiency (CE) dramatically decreased to 93.6% and 84.4% after static flow for 24 hours and 168 hours for N117 membranes, whereas no obvious CE drop was observed for IMS membranes after flowing (99.5% after 24 hours; 98.5% after 168 hours). The results may be attributed to the formation of a localized high-concentration iodide layer in the IMS membrane, which strongly electrostatically repels the charged iodide species in the posolyte. This mechanism effectively alleviates the cross-over issue.

Notably, as shown in the inset of FIG. 30, Zn—I flow batteries (FBs) with IMS membranes displayed smoothly increasing charging polarization profiles. In contrast, N117-based FBs exhibited sharply increased charging voltage profiles, which could be attributed to uneven Zn deposition in the negolyte side. Side reactions during battery cycling are a crucial factor influencing battery stability.

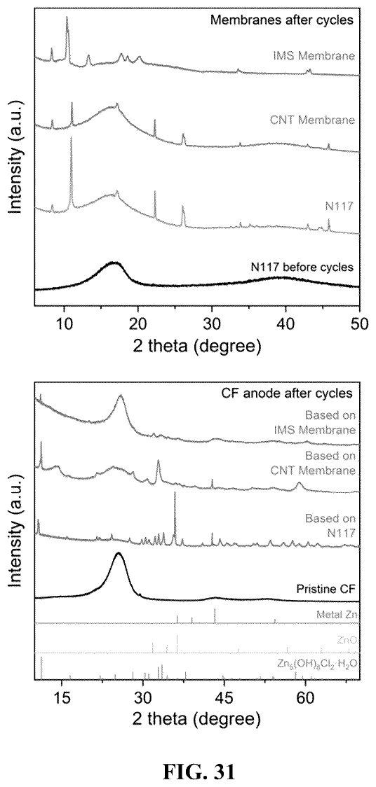

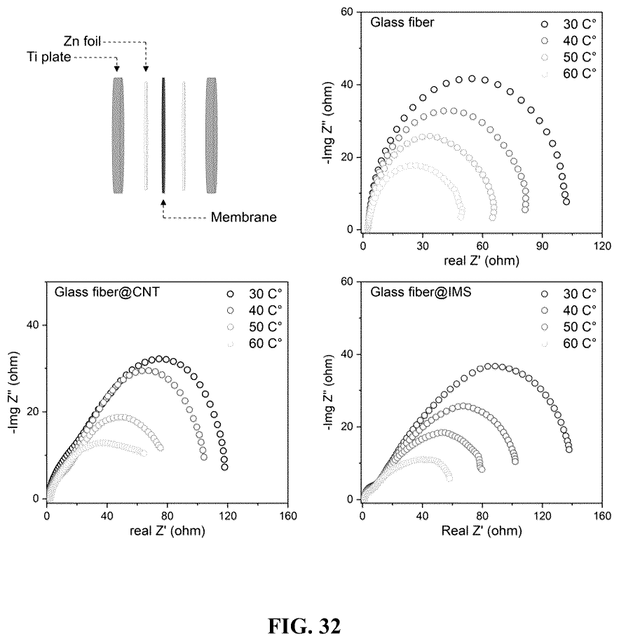

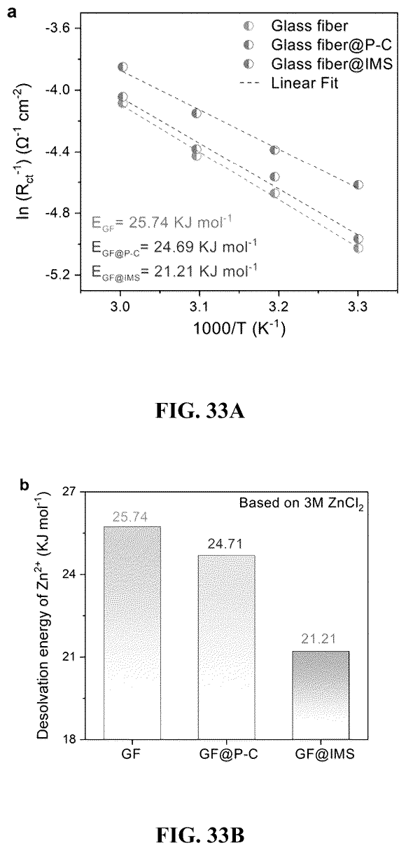

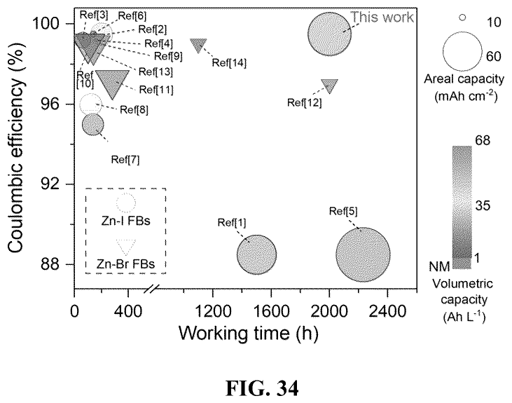

Referring to FIG. 31, XRD results using N117 membranes at the negolyte side of the discharge state exhibited dead dendrites or the Zn₅(OH)₈Cl₂·H₂O and ZnO as by-products. This result elucidated the sharp increase in charging voltage profiles due to the blocking of zinc deposition sites. In contrast, no obvious signals after using IMS membranes were observed after the same cycling, suggesting that IMS membranes could promote cycling reversibility of Zn plating/stripping in the negolyte side by the novel nano-channel chemistries, which was also demonstrated by low Zn desolvation energy (FIGS. 32-33B). Thus, the Zn—I FBs assembled with IMS membranes performed much superior battery performances when evaluated in more practical conditions by taking these vital parameters together, i.e., CE, volumetric/areal capacity and working lifetime, compared with those reported previously work based on Zn-polyhalide FBs in FIG. 34 and Table 1.

TABLE 1
Comparison of Zn-polyhalide FBs performance between
the present invention and previously reported work.

| | | | | Areal | Volumetric | |
|---|---|---|---|---|---|---|
| | | Working | | capacity | capacity | |
| Number | System | time | CE | (mAh cm⁻²) | (Ah L⁻¹) | Ref. |
| 1 | Zn—I FBs | 1500 | 88.5% | 61 | 63.5 | Angew. |
| | | | | | | Chem. 2018, 130, |
| | | | | | | 11341 |
| 2 | Zn—I FBs | 200 | 99.5% | 35 | 40 | J. Power |
| | | | | | | Sources 2021, |
| | | | | | | 484, 229238 |
| 3 | Zn—I FBs | 60 | 99.2% | 25 | / | Sci. Adv. |
| | | | | | | 2022, 8, eabq4456 |
| 4 | Zn—I FBs | 159 | 99.2% | 5.3 | / | Sci. Adv. |
| | | | | | | 2022, 8, eabq4456 |
| 5 | Zn—I FBs | 2230 | 88.5% | 160 | 57.6 | Sci. Bull. |
| | | | | | | 2021, 66, 889 |
| 6 | Zn—I FBs | 140 | 99.5% | 10 | 7 | Energy |
| | | | | | | Environ. Sci., |
| | | | | | | 2018, 11, 2010 |
| 7 | Zn—I FBs | 136 | 95% | 34 | 68 | Energy |
| | | | | | | Environ. Sci., |
| | | | | | | 2017, 10, 735 |
| 8 | Zn—I FBs | 120 | 96% | 35 | 35 | J. Mater. |
| | | | | | | Chem. A, 2022, |
| | | | | | | 10, 14090 |
| 9 | Zn—I FBs | 200 | 99% | 3.35 | / | J. Mater. |
| | | | | | | Chem. A, 2021, 9, |
| | | | | | | 16093 |
| 10 | Zn—Br FBs | 100 | 99% | 40 | / | Small 2019, |
| | | | | | | 15, 1901848 |
| 11 | Zn—Br FBs | 280 | 97.2% | 40 | 7.2 | Adv. Mater. |
| | | | | | | 2020, 32, 1906803 |
| 12 | Zn—Br FBs | 2000 | 97% | 20 | 5.82 | Energy |
| | | | | | | Environ. Sci., |
| | | | | | | 2020, 13, 2839 |
| 13 | Zn—Br FBs | 140 | 98.9% | 40 | 6 | Adv. Funct. |
| | | | | | | Mater. 2021, 31, |
| | | | | | | 2102913 |
| 14 | Zn—Br FBs | 1100 | 99% | 20 | 6 | J. Power |
| | | | | | | Sources, 2022, |
| | | | | | | 540, 231637 |
| This | Zn—I FBs | 2050 | 99.5% | 66.7 | 53.3 | / |
| invention | | | | | | |

### Example 12

### Techno-Economic Cost Analysis Based on Emerging AFBs

The LCOS was calculated from the webtool www.EnergyStorage.ninja (accessed 5 May 2023). The energy normalized installed cost (USD kWh⁻¹) for Zn—I FBs was calculated based on Lu's group or Darling's group.

Based on LCOS, the LCOS estimates were calculated for three emerging aqueous Zn-based flow batteries (FBs) across a range of durations (1-23 hours, 180 cycles per year), suitable for bulk energy storage. All systems exhibited a sharp reduction in LCOS for short durations (1-2 hours), stabilizing asymptotically for longer periods (>10 hours) due to diminishing power cost contributions. The developed Zn—I FBs systems in this work offered advantages in low energy cost and long operating lifetime but faced drawbacks in power cost due to modest current density. Zn—I FBs maintained a lower LCOS than the other Zn-based FBs systems across most energy-to-power (E/P) ratios due to its prolonged calendar life resulting from a low decay rate and energy cost.

The LCOS of Zn—I FBs was the same as Zn—Fe FBs for durations under 4 hours, primarily due to high power costs. Meanwhile, Zn—I FBs systems became competitive and exhibited lower LCOS at durations exceeding 11 hours compared to aqueous zinc flow batteries (AQFB). Notably, the cost analysis indicated that the developed Zn—I FBs systems remained competitive for long-duration applications (>11 hours). Furthermore, the total initial installed cost breakdown of the Zn—I FBs system for both short-duration (270 kWh/15 kW) and long-duration (3,600 kWh/15 kW) applications was provided, highlighting the contribution of each component.

Given the high areal capacity and long-duration performance of Zn—I flow batteries under IMS-based membranes, the levelized cost of storage (LCOS) was simulated and calculated. LCOS represents the normalized lifetime cost relative to cumulative delivered electricity. Investigations into LCOS variations were conducted based on discharge duration (or energy-to-power ratio, E/P) for three emerging zinc-bromine (Zn—Br) FBs, zinc-iron (Zn—Fe) FBs, Zn—I FBs systems and meanwhile the promising all-organic 2,6-DBEAQ (4,40-((9,10-anthraquinone-2,6-diyl)dioxy) dibutyrate) redox flow battery (AQFB) as the reference.

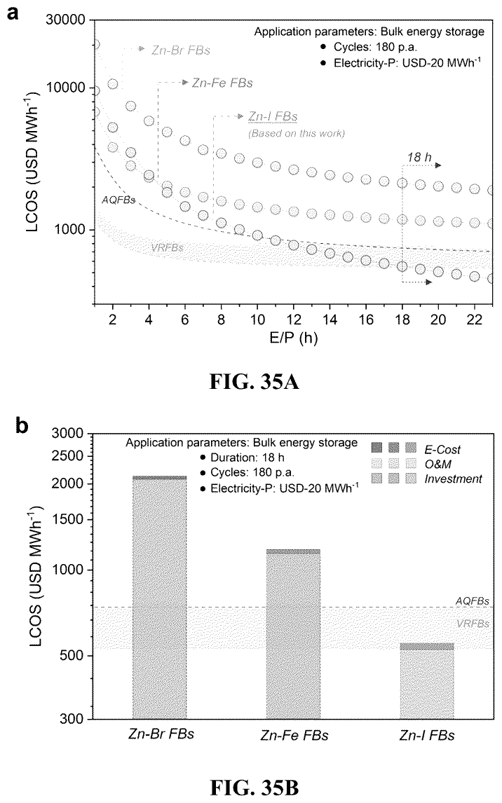

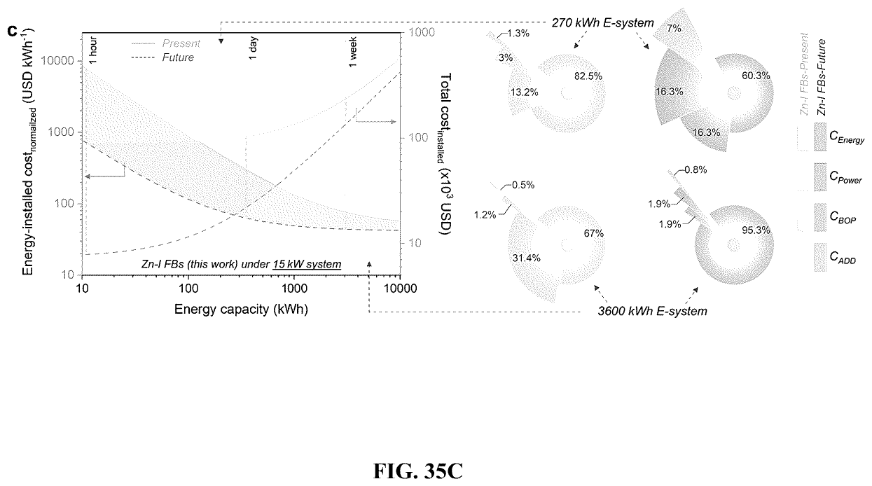

Notably, reported aqueous flow batteries (AFBs) testing durations in literature are much shorter than projected shelf life derived from decay rate measurements. Consequently, LCOS calculated based solely on projected shelf life offers initial comparisons for nascent laboratory-scale AFB prototypes (FIG. 35A), while it is unsuitable for direct benchmarking against the mature vanadium redox flow batteries (VRFBs). As such, the LCOS assigned to the commercialized VRFB serves as a visual reference, intended for contextual understanding rather than direct comparison with laboratory-based AFBs. FIG. 35A displays LCOS estimations for three emerging aqueous Zn-based FBs across a range of durations (1-23 hours, 180 cycles per year) suited for bulk long duration energy storage. Firstly, the LCOS of commercial VRFBs was indicated as a reference zone, summarized by Schmidt's group and Zakeri's group. All systems exhibited sharp LCOS reduction for short durations (1-2 hours), stabilizing asymptotically for longer periods (>10 hours) due to diminishing power cost contributions. The developed Zn—I FBs systems in this work offered advantages in low energy cost and long operating lifetime but faces drawbacks in power cost due to modest current density. As depicted in FIG. 35A, Zn—I FBs maintained lower LCOS than the other Zn-based FBs systems across most energy/power (E/P) ratios due to its prolonged calendar life from low decay rate and energy cost. The LCOS of Zn—I FBs was large than Zn—Fe FBs before durations of 4 hours, which was due to the short-duration of operation being greatly influenced by power costs. Meanwhile, Zn—I FBs systems become competitive and lower LCOS at durations exceeding 11 hours compared to AQFB. Notably, the cost analysis indicated that the developed Zn—I FBs systems remained competitive for long-duration applications (≥11 hours). For a detailed breakdown, FIG. 35B presented the LCOS analysis of Zn—I FBs compared with Zn—Br FBs and Zn—Fe FBs systems using an E/P ratio of 18 hours, focused on bulk storage applications. The result significantly demonstrated the promising potential of constructing low-cost Zn—I FBs systems for large-scale long duration energy storage.

Further analysis involves breaking down the total initial installed cost of the Zn—I FBs system for both short-duration (270 kWh/15 kW, 22 h) and long-duration (3,600 kWh/15 kW, 10 days) applications, highlighting the contribution of each component (FIG. 35C).

In the case of the current Zn—I FBs configuration, the power cost represented 82.5% of the total capital cost for the short-duration application, which decreases to 31.4% for the long-duration application. This calculated analysis emphasized the need to reduce the power cost of Zn—I FBs for short-duration storage, which requires improvements in reducing the cost of the Nafion-based membrane.

Additionally, a lower cost estimate is projected, depicted by the dark color zone in the right of FIG. 35C (future Zn—I FBs), incorporating two improvements for the future: (1) using a lower cost non-fluorinated membrane with higher ionic conductivity compared to Nafion (i.e., porous membrane with 1.0 Ωcm² in K⁺ conductive electrolytes at 20-fold times lower costs than Nafion membrane) (2) optimizing the volumetric ratio of positive/negative electrolyte ratio to improve the utilization rate of electrolytes.

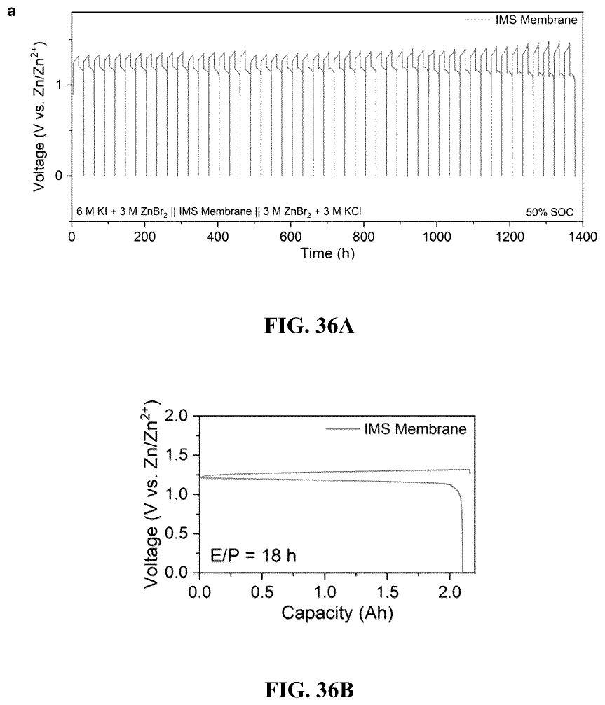

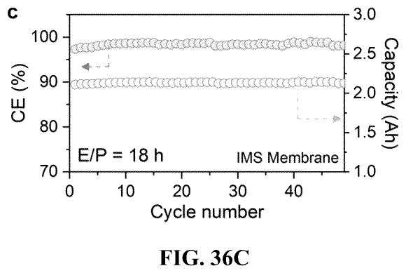

With these enhancements, the total normalized installed cost could decrease by 81.4% compared to the current laboratory-scale Zn—I FBs under an 18-h duration. In this regard, the power cost accounts for only 16.3% of the total cost (FIG. 35C, top circle). Additionally, the Zn—I FBs flow cells utilizing the IMS membrane exhibit high cycling stability with long discharge/charge durations (about 18 h for each set) (FIGS. 36A-36C), further supporting their applicability for long-duration energy storage. Therefore, the developed Zn—I FBs system offers both industrial-relevant cycling stability and the potential for a cost-effective levelized storage cost in various large-scale energy storage applications.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### INDUSTRIAL APPLICABILITY

The IMS membrane of the present invention can simultaneously address cross-over and water migration, providing high reversibility and long duration for Zn—I FBs.

Furthermore, techno-economic cost analysis uncovers that IMS membrane-based Zn—I FBs systems display a competitive levelized cost of energy storage for long-term energy storage (551.98 USD MWh⁻ at an energy-to-power ratio of 18 h). This work may offer an insightful frontier to the precise regulation of water migration induced by hydrated ions for achieving hybrid Zn-based flow batteries with long-duration energy storage.

### Definition

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (m) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “ionic-molecular sieving membrane” refers to a type of membrane with precise size-selective properties, designed to restrict the passage of specific ions and molecules while allowing others of smaller or related sizes to pass through. The membrane is engineered to achieve highly selective blocking of certain ions or molecules, and is commonly used for separation, concentration, or filtration of specific components in liquids.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. A size-sieving enhanced zinc-iodine flow battery system for mitigating water/hydrated ion cluster migration, comprising:
an anolyte;
a catholyte;
an anode configured to be in contact with the anolyte;
a cathode configured to be in contact with the catholyte; and
a separator interposed between the anode and the cathode,
wherein the separator comprises an ionic-molecular sieve membrane, offering precise size-sieving effects to prevent migration of water/hydrated ion clusters,
wherein the size-sieving enhanced zinc-iodine flow battery system demonstrates stable cycling at an areal capacity of 66.4 mAh cm⁻² and a volumetric capacity of 53.2 Ah L⁻¹_{posolyte} over at least 500 cycles at 50% state-of-charge.

2. The size-sieving enhanced zinc-iodine flow battery system of claim 1, wherein each of the cathode and anode further comprises a carbon felt.

3. The size-sieving enhanced zinc-iodine flow battery system of claim 2, wherein the carbon felt has a geometric area of 1.0-5.0 cm² and a thickness of 1-5 mm.

4. The size-sieving enhanced zinc-iodine flow battery system of claim 1, wherein the catholyte comprises 6 M potassium iodide and 3 M zinc bromide.

5. The size-sieving enhanced zinc-iodine flow battery system of claim 1, wherein the anolyte comprises 3 M zinc bromide and 3 M potassium chloride.

6. The size-sieving enhanced zinc-iodine flow battery system of claim 1, wherein the electrolytes on the cathode and anode side are flowed by a peristaltic pump.

7. The size-sieving enhanced zinc-iodine flow battery system of claim 1, wherein the ionic-molecular sieve membrane has a pore size of 0.55 nm to 0.65 nm.

8. The size-sieving enhanced zinc-iodine flow battery system of claim 1, wherein the ionic-molecular sieve membrane has a thickness of 20-40 μm.

9. The size-sieving enhanced zinc-iodine flow battery system of claim 1, wherein the anolyte or the catholyte is disposed in a tank.

10. The size-sieving enhanced zinc-iodine flow battery system of claim 1, wherein the cathode uses graphite felt as the current collector.

11. The size-sieving enhanced zinc-iodine flow battery system of claim 1, wherein the anode uses graphite felt as the current collector.

12. The size-sieving enhanced zinc-iodine flow battery system of claim 1, further comprising a stainless-steel endplate, a PVC chamber, a PTFE gasket, a PTFE pad, a PTFE tube and a carbon plate.

13. The size-sieving enhanced zinc-iodine flow battery system of claim 1, wherein the size-sieving enhanced zinc-iodine flow battery system delivers a low self-discharge rate in retaining a coulombic efficiency of at least 95% after static flowing for 3 days at 50% SOC.
